(19) United States
(12) Patent Application Publication
(10) Pub. No.: US 2026/0052040 A1
(43) Pub. Date: Feb. 19, 2026

(54) DEVICE AND METHOD FOR PERFORMING SOUNDING SEQUENCE IN WIRELESS COMMUNICATION SYSTEM

(71) Applicant: Samsung Electronics Co., Ltd., Suwon-si (KR)

(72) Inventor: Eun Sung JEON, Suwon-si (KR)

(73) Assignee: Samsung Electronics Co., Ltd., Suwon-si (KR)

(21) Appl. No.: 19/251,065

(22) Filed: Jun. 26, 2025

(30) Foreign Application Priority Data
Aug. 19, 2024 (KR) 10-2024-0110748

(51) Int. Cl. H04L 25/02; H04B 17/309; H04W 84/12

(52) U.S. Cl. CPC H04L 25/0204; H04B 17/346; H04W 84/12

(57) ABSTRACT

A method of a station communicating with an access point in a wireless local area network (WLAN) system includes receiving a sounding null data packet (NDP) from the access point, estimating channel information based on the sounding NDP, converting a size of the channel information to match a size of an input layer of an encoder to obtain converted channel information, encoding the converted channel information based on the encoder to obtain encoded channel information, and providing feedback on the encoded channel information to the access point.

### CROSS-REFERENCE TO RELATED APPLICATION(S)

This U.S. non-provisional application claims priority under 35 USC § 119 to Korean Patent Application No. 10-2024-0110748, filed on Aug. 19, 2024, in the Korean Intellectual Property Office, the disclosure of which is herein incorporated by reference in its entirety.

### BACKGROUND

Example embodiments relate to a device and a method for performing a sounding sequence in a wireless communication system.

A wireless local area network (WLAN) is a type of wireless communication technology for connecting two or more devices using wireless signal transmission. WLAN technology is typically based on the IEEE 802.11 standard. Starting with the 802.11ac standard, multi-user multiple-input multiple-output (MU-MIMO) technology has allowed simultaneous (or contemporaneous) data transmission to a plurality of users.

In an MU-MIMO communication environment, a beamforming process may be used to improve communication performance. The beamforming process includes a sounding sequence. The sounding sequence may allow a beamformee to provide feedback on channel information to a beamformer. A larger size of feedback channel information results in greater overhead.

### SUMMARY

Example embodiments provide a device and a method for performing a sounding sequence in a wireless communication system. Example embodiments may enable reduction of a size of feedback channel information

According to example embodiments, a method of a station communicating with an access point in a wireless local area network (WLAN) system includes receiving a sounding null data packet (NDP) from the access point, estimating channel information based on the sounding NDP, converting a size of the channel information to match a size of an input layer of an encoder to obtain converted channel information, encoding the converted channel information based on the encoder to obtain encoded channel information, and providing feedback on the encoded channel information to the access point.

According to example embodiments, a station communicating with an access point in a wireless local area network (WLAN) system includes one or more transceivers, one or more processors electrically connected to the one or more transceivers, and one or more memories electrically connected to the one or more processors and configured to store one or more instructions, wherein the one or more processors is configured to execute the one or more instructions to receive a sounding null data packet (NDP) from the access point through the one or more transceivers, estimate channel information based on the sounding NDP, convert a size of the channel information to match a size of an input layer of an encoder to obtain converted channel information, the encoder being stored in the one or more memories, encode the converted channel information based on the encoder to obtain encoded channel information, and provide feedback on the encoded channel information to the access point through the one or more transceivers.

According to example embodiments, a method of an access point communicating with a station in a wireless local area network (WLAN) system includes receiving channel information from the station, decoding the channel information based on a decoder to obtain decoded channel information, converting a size of the decoded channel information to match a number of subcarriers over which the channel information is transmitted to obtain converted channel information, and performing beamforming based on the converted channel information.

### BRIEF DESCRIPTION OF DRAWINGS

FIG. 1 is a diagram illustrating a wireless communication system according to example embodiments.

FIG. 2 is a diagram illustrating a structure of an extremely high throughput (EHT) trigger-based (TB) physical protocol data unit (PPDU).

FIG. 3 is a diagram illustrating a structure of the EHT MU PPDU.

FIG. 4 is a diagram illustrating single-user based channel sounding according to example embodiments.

FIG. 5 is a diagram illustrating multi-user based channel sounding according to example embodiments.

FIG. 6 is a diagram illustrating a frame structure of an EHT NDPA frame.

FIG. 7 is a diagram illustrating a frame structure of an EHT sounding NDP frame.

FIG. 8 is a diagram illustrating a structure of an EHT CBR frame.

FIG. 9 is a diagram illustrating an EHT MIMO control field of FIG. 8.

FIG. 10 is a diagram illustrating a WLAN beamforming system.

FIG. 11 is a diagram illustrating subcarrier grouping.

FIG. 12 is a diagram illustrating an STA according to example embodiments.

FIG. 13 is a diagram illustrating an encoder of FIG. 12 according to example embodiments.

FIG. 14 is a diagram illustrating an STA according to example embodiments.

FIG. 15 is a diagram illustrating an STA according to example embodiments.

FIGS. 16 to 18 are diagrams illustrating a processing operation of input data of an encoder according to example embodiments.

FIG. 19 is a diagram illustrating an access point (AP) according to example embodiments.

FIG. 20 is a diagram illustrating a decoder of FIG. 19 according to example embodiments.

FIG. 21 is a waveform diagram illustrating an example of a resolution for each angle information.

FIG. 22 is a flowchart illustrating a method of operating an STA according to example embodiments.

FIG. 23 is a flowchart illustrating a method of converting an STA according to example embodiments.

FIG. 24 is a flowchart illustrating a method of operating an AP according to example embodiments.

FIG. 25 is a block diagram of a wireless communication device according to example embodiments.

### DETAILED DESCRIPTION

Hereinafter, example embodiments will be described with reference to the accompanying drawings.

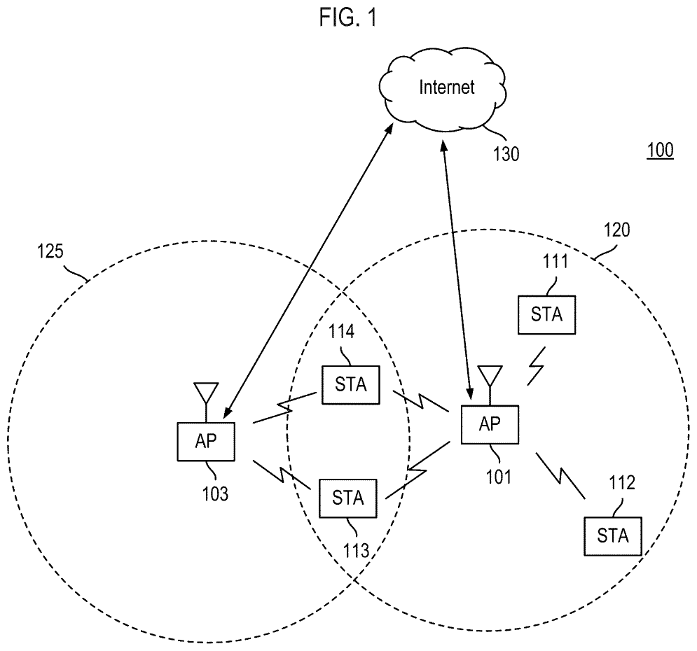

FIG. 1 is a diagram illustrating a wireless communication system according to example embodiments.

Referring to FIG. 1, the wireless communication system 100 may include a plurality of access points (APs) 101 and 103 and/or a plurality of stations (STAs) 111 to 114. For example, the APs 101 and 103 may communicate with at least one network 130 such as Internet, an internet protocol (IP) network, or the like.

The APs 101 and 103 may provide wireless access to the network 130 such that the STAs 111 to 114 within coverage areas 120 and 125 may use communication services. For example, the APs 101 and 103 may communicate with each other using wireless fidelity (WiFi) or other WLAN communication technologies. The APs 101 and 103 may communicate with a plurality of STAs 111 to 114 using WiFi or other WLAN communication technologies.

For reference, other well-known terms such as “router” and “gateway” may be used instead of “AP” or “access point” depending on the network type. In a WLAN, an AP may be provided for a wireless channel. An AP may be identified as an STA for another AP side depending on an operation thereof. In the present disclosure, the AP may also be referred to as a device, a wireless device, a communication device, or the like.

Also, an STA may be used instead of other well-known terms, such as a mobile station, a subscriber station, a remote terminal, a user equipment, a wireless terminal, a user device, or a user, depending on the network type. For ease of description, the term “STA” is used to indicate a remote wireless device that wirelessly accesses an AP or accesses a wireless channel within a WLAN. An STA may be identified as an AP to another STA side, depending on an operation thereof. In the present disclosure, the STA may also be referred to as a device, a wireless device, or a communication device.

In example embodiments, the APs 101 and 103 may be included in different devices, respectively. or may be included in a single AP multiple-link device (MLD). The STAs 111 to 114 may be included in different devices, respectively, or may be included in a single non-AP MLD.

Dashed lines indicate an approximate extent of the coverage areas 120 and 125. The coverage areas 120 and 125 are illustrated as having a roughly circular shape, for simplicity of description and brevity of the drawings. However, the coverage areas 120 and 125 related to the APs 101 and 103 may have different shapes reflecting various changes in a wireless environment related to natural or artificial obstructions, or may have other shapes including irregular shapes depending on the settings of the APs 101 and 103.

The APs 101 and 103 may include circuitry and/or program to manage uplink multi-user (UL MU) or downlink multi-user (DL MU) transmission in a WLAN system.

FIG. 1 illustrates only an example of the wireless communication system 100, and example embodiments are not limited thereto.

For example, the wireless communication system 100 may include an arbitrary number of APs and an arbitrary number of STAs disposed arbitrarily and appropriately. The AP 101 may directly communicate with an arbitrary number of STAs. For example, the AP 101 may provide a wireless broadband access to the network 130 to the STAs 111 to 114.

Similarly, the APs 101 and 103 may each communicate directly with the network 130 and may provide wireless broadband access to the network 130 to the STAs 111 to 114. Also, the APs 101 and 103 may implement connections to various external networks such as an external telephone network or a data network. Hereinafter, the configuration and operation of the AP 101 and the STA 111 will be mainly described to describe example embodiments, and the described examples may also be applied to the remaining AP 103 and STAs 112 to 114.

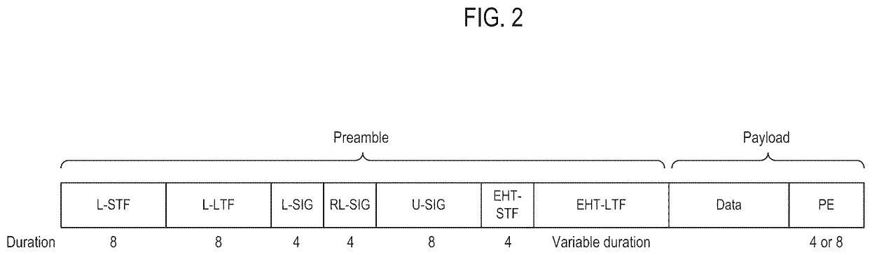

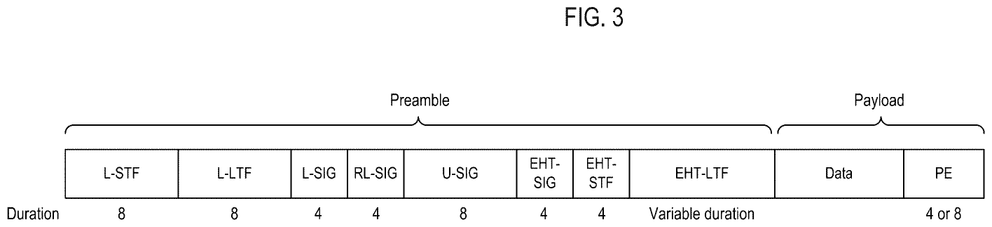

FIG. 2 is a diagram illustrating a structure of an extremely high throughput (EHT) trigger-based (TB) physical protocol data unit (PPDU), and FIG. 3 is a diagram illustrating a structure of the EHT MU PPDU.

Referring to FIGS. 2 and 3, each EHT PPDU may include a preamble, including a plurality of training fields and a plurality of signaling fields, and/or a payload including a data field and a packet extension (PE).

For example, each EHT PPDU may include a legacy-short training field (L-STF), a legacy-long training field (L-LTF), a legacy-signal field (L-SIG), a repeated legacy-signal field (RL-SIG), a universal signal field (U-SIG), an extremely high throughput-short training field (EHT-STF), an extremely high throughput-long training field (EHT-LTF), a data field, or a PE field for packet extension.

The EHT TB PPDU of FIG. 2 does not include an extremely high throughput-signal (EHT-SIG) field, but a symbol of the EHT-STF may be repeated. The EHT MU PPDU of FIG. 3 may include a plurality of orthogonal frequency division multiplexing symbols (OFDM) and may further include an EHT-SIG.

In the case of the EHT TB PPDU of FIG. 2, a trigger frame may be required to (or otherwise, may) indicate a frequency resource before uplink transmission.

L-STF may include a short training OFDM symbol and may be used for frame detection, AGC automatic gain control, diversity detection, and coarse frequency/time synchronization.

L-LTF may include a long training OFDM symbol and may be used for fine frequency/time synchronization and channel estimation.

L-SIG may be used for transmitting control information and may include information on a data rate and a data length. For reference, L-SIG may be transmitted repeatedly, and a format in which L-SIG is repeated is referred to as RL-SIG.

U-SIG may be positioned immediately after (or next to) RL-SIG field, and may include two OFDM symbols encoded commonly. For example, U-SIG may include ‘Version-independent fields’ and ‘Version-dependent fields’, and ‘Version-dependent fields’ may be disposed after ‘Version-independent fields,’ wherein ‘Version-independent fields’ may have a fixed location and bit definition across different generations/physical versions.

For example, ‘Version-independent fields’ may include the following control information:
1) PHY version identifier (e.g., a physical version identifier consisting of (or including) 3 bits),
2) UL/DL flag (consists of (or including) 1 bit),
3) BSS color (e.g., a basic service set (BSS) color field that an identifier for BSS),
4) TXOP duration (e.g., a field indicating the remaining time for a current transmission opportunity (TXOP) period), and
5) Bandwidth (e.g., a bandwidth field; note that the bandwidth field may also carry some puncturing information.

In addition, ‘Version-dependent fields’ may have a variable bit definition for each physical version.

For example, ‘Version-dependent fields’ may include the following control information:
1) PPDU type (a field indicating the PPDU type),
2) EHT-SIG MCS (a field indicating a modulation and coding scheme (MCS) applied to EHT-SIG, which is present in U-SIG of an EHT PPDU transmitted to MU),
3) Number of EHT-SIG Symbols (a field indicating the number of symbols used for EHT-SIG, which is present in U-SIG of EHT PPDU transmitted to MU).

U-SIG may further include various other types of information in addition to the above-mentioned control information, or may not include a portion of the above-mentioned control information. In environments other than MU environments, some information may be added to U-SIG, or some information of U-SIG may be omitted.

EHT-SIG is positioned immediately after (or next to) the U-SIG field within an EHT PPDU transmitted to MU and may have variable MCS and length.

For example, EHT-SIG may include a common field including common control information and a user-specific field including user-specific control information.

The common field may be encoded separately from the user-specific field. The common field may include resource unit (RU) allocation-related information (for example, RU Allocation subfield), and the user-specific field may include information similar to the information included in the user-specific field of high efficiency (HF)-SIG-B (for example, user information allocated to each RU).

For reference, at least one compression mode, in which an RU Allocation subfield is not present, may be present in a common field of the EHT-SIG field of an EHT PPDU transmitted to MU. Although EHT-SIG may basically be used in PDUs for MU, it may also be used in PDU for single-user (SU) transmission, unlike HE PPDU, when an overhead of U-SIG increases.

The EHT-SIG field may be configured as described above, and a more detailed description of the EHT-SIG will be omitted.

The EHT-STF field is used to improve automatic gain control (AGC) estimation in multiple-input multiple-output (MIMO) transmission.

The EHT-LTF field is used for MIMO channel estimation between an output set of a constellation mapper and a receive chain.

As described above, various EHT PDUs may be used in the Institute of Electrical and Electronics Engineers (IEEE) standard, and each field of the preamble and payload of the EHT PPDU may be configured as described above.

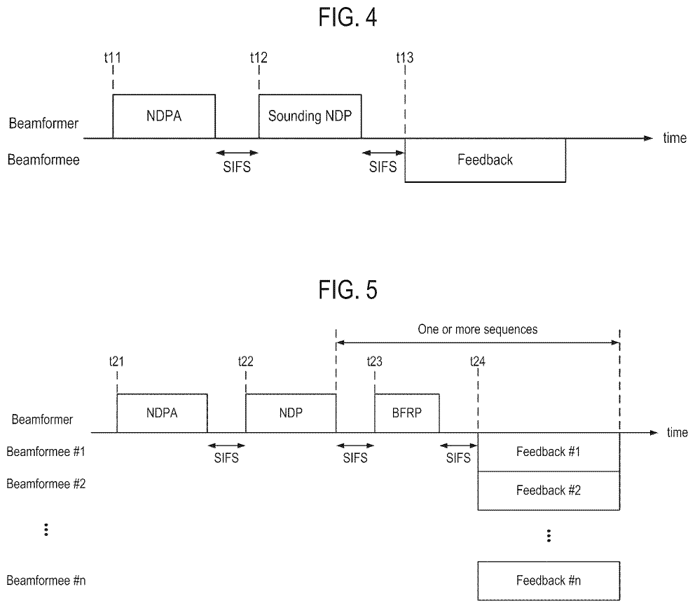

FIG. 4 is a diagram illustrating single-user based channel sounding according to example embodiments.

Referring to FIG. 4, channel sounding may be performed through a beamformer and a beamformee. In example embodiments, the beamformer may be an AP, and the beamformee may be an STA. Hereinafter, the terms “beamformer” and “AP” will be used interchangeably, and the terms “beamformee” and “STA” will be used interchangeably.

In a WLAN system, beamforming may be performed to enhance reception performance of a single user or multiple users. SU-MIMO beamforming and DL MU-MIMO beamforming are techniques used by a station (STA) including a plurality of antennas to steer signals based on known channels, contributing to increased throughput. All spatial streams of a transmitted signal may be designed to be received at a single STA of an RU or multi-RU (MRU) through SU-MIMO. Through DL MU-MIMO, disjoint subsets of spatial streams may be designed to be received at different STAs of an RU or MRU having a size of 242 tones or more.

The beamformer may receive channel information from the beamformee. The beamformer may transmit a sounding signal for channel estimation and channel information feedback on the beamformee to receive channel information. A process of transmitting or receiving a series of signals including a sounding signal for the beamformer to receive channel state information from the beamformee may be defined as a sounding sequence (or a sounding protocol). FIG. 4 illustrates an example of a sounding sequence for a single user.

The AP may enable beamforming for optimal (or improved) signal transmission and reception through the sounding sequence.

The sounding sequence may be classified into a non-trigger-based sounding sequence and a trigger-based sounding sequence as an explicit feedback mechanism. In all sequences, the beamformee may estimate a channel using a training signal (for example, sounding NDP) and provide feedback on a state of the estimated channel (or channel information) to the beamformer. The beamformer may derive a steering matrix based on the feedback information. The sounding sequence of FIG. 4 is ‘non-trigger-based’ for a single user.

At time t11, the beamformer may transmit an NDP announcement (NDPA) frame to the beamformee to notify transmission of a null data packet (NDP) before transmitting the NDP, a sounding signal. The NDPA frame may be a control frame used to notify that the NDP is to be transmitted in a sounding sequence. The NDP may be referred to as a ‘sounding NDP’ or ‘sounding signal,’ as a sounding signal for the sounding sequence. When receiving the NDPA frame from the beamformer, the beamformee may prepare for channel information estimation and feedback before receiving the NDP.

After transmitting the NDPA frame, the beamformer may transmit the NDP to the beamformee after a short inter-frame space (SIFS) interval (for example, at time t12). For example, SIFS may be 16 us.

The beamformee may receive the NDP and perform channel estimation based on the received NDP. In a non-trigger-based sounding sequence, the beamformee may carry the channel information estimated from the NDP in a compressed beamforming report (CBR) frame and provide feedback on the carried channel information to the beamformer within SIFS after the transmission of the NDP (for example, at time t13).

FIG. 5 is a diagram illustrating multi-user based channel sounding according to example embodiments. FIG. 5 illustrates an example of trigger-based channel sounding for multiple users.

Referring to FIG. 5, a sounding sequence according to example embodiments may be performed by a beamformer and a plurality of beamformees, for example, n beamformees (wherein n is a positive integer greater than or equal to 2). The same (or similar) or different protocol standards may be supported for the plurality of beamformees.

At time t21, the beamformer may transmit an NDPA frame to the plurality of beamformees before transmitting the NDP.

After completing the transmission of the NDPA frame, at time t22 within SIFS, the beamformer may transmit the NDP to the plurality of beamformees. In a trigger-based sounding sequence, the beamformer may transmit a beamforming report poll (BFRP) frame to request feedback on channel information from each beamformee after transmitting the NDPA frame and the NDP. An operation of transmitting the BFRP frame may be considered to be a trigger for a feedback request. Transmitting a BFRP frame is a difference between a non-trigger-based sequence and a trigger-based sounding sequence. After transmitting the NDP, the beamformer may transmit the BFRP frame at time t23 within SIFS.

Each beamformee may perform channel estimation based on the received NDP. At time t24 within SIFS after transmitting the BFRP frame, each beamformee may carry the estimated channel information in a CBR and transmit the carried channel information to the beamformer.

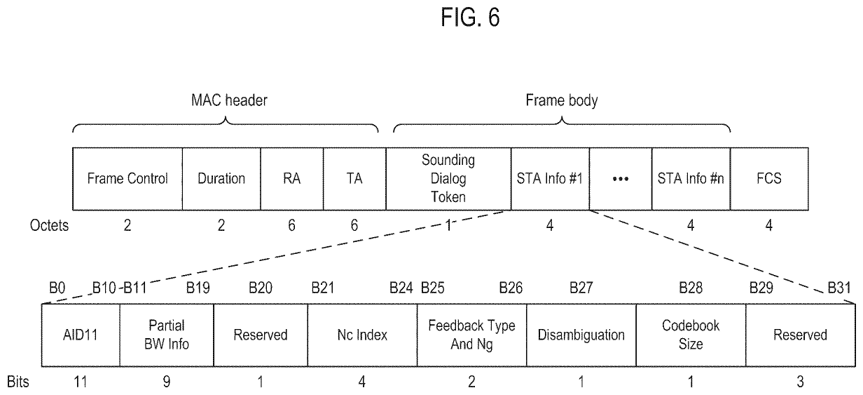

FIG. 6 is a diagram illustrating a frame structure of an EHT NDPA frame.

Referring to FIG. 6, the EHT NDPA frame may include a multiple access channel (MAC) header, a frame body, and/or a frame check sequence (FCS) field. The MAC header may include a frame control field, a duration field, an RA field, and/or a TA field. The frame body may include a sounding dialogue token number field and/or n STA information (STA Info) fields.

The frame control field may include information on a version of a MAC protocol and other additional control information. The duration field may include time information for setting an NAV network allocation vector or information on a user identifier (for example, association identifier (AID)). The RA field may include address information of a beamformee receiving the EHT NDPA frame. The TA field may include address information of a beamformer transmitting the EHT NDPA frame.

The sounding dialogue token number field may be referred to as a sounding sequence field, and may include identification information for the EHT NDPA frame.

The STA Info field may be referred to as a user information field. The STA Info field may correspond to each STA, and one or more STA Info fields may be included in the EHT NDPA frame. When there are a plurality of STA Info fields, the number of STA Info fields may correspond to the number of a plurality of beamformees receiving the EHT NDPA frame. For example, when the beamformer intends (or is otherwise, configured) to perform beamforming for n multiple users, the beamformer may insert n STA Info fields into the NDPA frame. For example, each STA Info field may have a size of 4 bytes.

Each STA information subfield may include an AID subfield, a Partial BW Info subfield, an Nc Index subfield, a Feedback Type And Ng subfield, a Disambiguation subfield, a Codebook Size subfield, and/or a Reserved subfield. As illustrated in the drawing, the Reserved subfield may be inserted between the Partial BW Info subfield and the Nc Index subfield or may be inserted after the Codebook Size subfield.

The AID subfield may include ID information for an STA. The ID information may be information assigned by the beamformer to each STA, a beamforming target. In the case of an EHT NDPA frame, the AID subfield may be an AID11 subfield defined in the IEEE standard. The AID11 subfield may include an identifier of an STA expected to process the subsequent EHT sounding NDP and prepare sounding feedback.

The Partial BW Info subfield may include a resolution subfield and a feedback bitmap subfield. The resolution subfield indicates a bandwidth resolution for each bit in the feedback bitmap subfield. The feedback bitmap subfield indicates whether feedback is requested for each resolution bandwidth, with the order determined from a lowest frequency to a highest frequency. For example, the feedback bitmap subfield may include bits B1 to B8, and the bit B1 set to 1 may indicate a feedback request for the lowest frequency in the indicated resolution bandwidth.

The Nc Index subfield may represent (the number of columns in a compressed beamforming feedback matrix-1) when the Feedback Type And Ng subfield and the Codebook Size subfield indicates a single user (SU) or multiple users (MU). Alternatively, the Nc Index subfield may represent (the number of spatial streams in a CQI report-1) when the Feedback Type And Ng subfield and the Codebook Size subfield indicate CQI.

The Feedback Type And Ng subfield and the Codebook Size subfield may each have 1 bit. A combination of bits in the Feedback Type And Ng subfield and the Codebook Size subfield may indicate whether transmission is for SU or MU, a subcarrier grouping value Ng, and a quantization resolution.

The Disambiguation subfield may prevent other STAs (for example, non-EHT STAs) from incorrectly identifying an AID in an EHT NDPA frame (or reduce the likelihood thereof).

Each STA may identify an STA information subfield having a matching AID value in the NDPA frame and refer to parameters for providing feedback on channel information, such as resolution bandwidth, requested frequency, Nc, feedback type, Ng, and/or quantization resolution, from the identified STA information subfield.

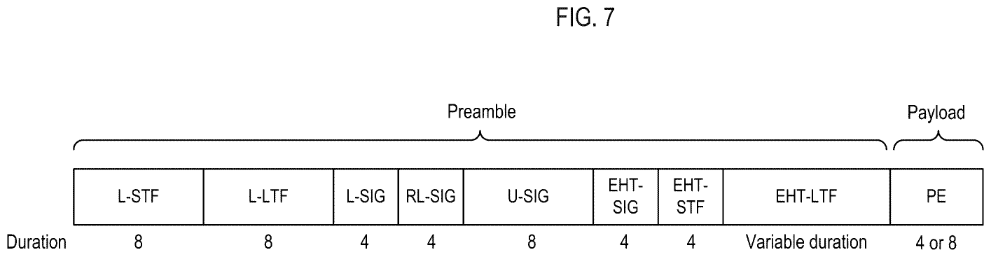

FIG. 7 is a diagram illustrating a frame structure of an EHT sounding NDP frame.

Referring to FIG. 7, an EHT sounding NDP frame may include L-STF, L-LTF, L-SIG, RL-SIG, U-SIG, EHT-SIG, EHT-STF, EHT-LTF, and/or PE. Unless otherwise stated, functions of the above-mentioned fields may be the same as (or similar to) those of the fields included in the EHT TB PPDU and EHT MU PPDU.

In an EHT sounding NDP frame, a single EHT-SIG symbol is encoded into EHT-MCS 0. The EHT sounding NDP frame may be considered to be an EHT MU PPDU having no data field. The EHT-SIG field may not include a user-specific field. When the beamforming subfield in EHT-SIG is 1, a receiver (for example, STA of the EHT sounding NDP frame) may not perform channel smoothing when reporting the compressed beamforming feedback.

The STA, a receiver of the EHT sounding NDP frame, may estimate the channel through the EHT-LTF included in the frame and report the estimated channel information to the AP through a CBR frame.

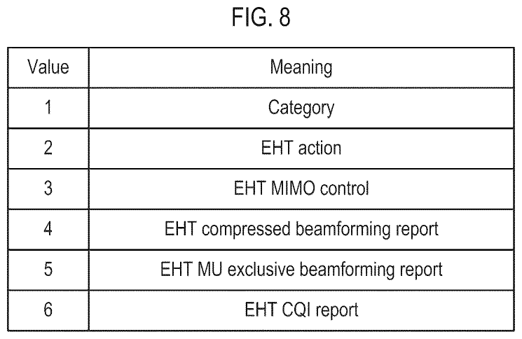

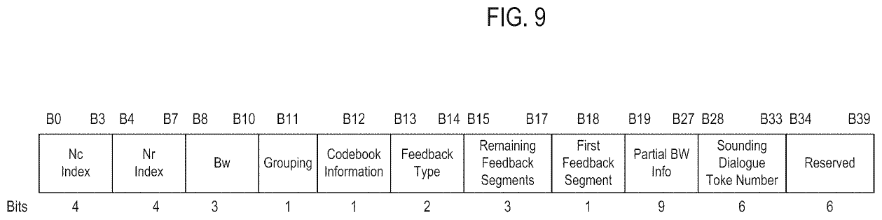

FIG. 8 is a diagram illustrating a structure of an EHT CBR frame, and FIG. 9 is a diagram illustrating an EHT MIMO control field of FIG. 8.

Referring to FIG. 8, an EHT CBR frame may be a frame generated by an STA (for example, a beamformer) and may sequentially include a Category field, an EHT Action field, an EHT MIMO Control field, an EHT Compressed Beamforming Report field, an EHT MU Exclusive Beamforming Report field, and/or an EHT CQI Report field.

The Category field may be set to a value indicating an EHT category (for example, an EHT Action frame), and the EHT Action field may be set to a value indicating an EHT Compressed Beamforming frame.

The EHT MIMO Control field may include information on the EHT CBR frame. Referring to FIG. 9, the EHT MIMO Control field may include subfields such as Nc Index, Nr Index, BW, Grouping, Codebook Information, Feedback Type, Remaining Feedback Segments, First Feedback Segment, Partial BW Info, Sounding Dialogue Token Number, and/or a reserved subfield.

The Nc Index subfield may represent (the number of columns in a compressed beamforming feedback matrix-1) when the Feedback Type subfield indicates SU or MU, and may represent (the number of spatial streams-1) when the Feedback Type subfield indicates CQI.

The Nr Index subfield may represent (the number of rows in a compressed beamforming feedback matrix-1) when the Feedback Type subfield indicates SU or MU, and may be reserved when the Feedback Type subfield indicates CQI.

The BW subfield may correspond to the BW (bandwidth) of the EHT sounding NDP.

The Grouping subfield may indicate a grouping value Ng when the Feedback Type subfield indicates SU or MU, and may be reserved when the Feedback Type subfield indicates CQI.

The Codebook Information subfield may indicate a size of the codebook entries, information related to quantization.

The Feedback Type subfield may indicate the feedback type (for example, SU, MU, or CQI).

The Remaining Feedback Segments subfield may indicate the number of remaining feedback segments for the associated EHT compressed beamforming/CQI frame.

The First Feedback Segment subfield may be set to 0 or 1. The First Feedback Segment subfield may be set to 1 for a first feedback segment of a segmented report or the only feedback segment of an unsegmented report. Alternatively, the First Feedback Segment subfield may be set to 0 when it is not the first feedback segment or when the EHT Compressed Beamforming Report field and the EHT MU Exclusive Beamforming Report field are not present in a frame.

The Partial BW Info subfield and Sounding Dialogue Token Number subfield may be the same as (or similar to) the subfields included in the aforementioned EHT NDPA frame.

The EHT Compressed Beamforming Report field may transmit an average signal-to-noise ratio (SNR) of each space-time stream used for data transmission and the compressed beamforming feedback matrix. For example, the EHT Compressed Beamforming Report field may be configured as illustrated in Table 1.

TABLE 1

| Field | Size (bits) | Meaning |
|---|---|---|
| Average SNR of | 8 | SNR at the beamformer for spacetime stream 1 |
| Space Time Stream 1 | | averaged over all data cub carriers |
| ≡ | ≡ | ≡ |
| Average SNR of | 8 | SNR at the beamformer for spacetime stream |
| Space-Time Stream [symbol] | | No averaged over all data subcarriers |
| Compressed beamforming feedback | Na [symbol] | Compressed beamforming feedback matrix in |
| matrix [symbol] for subcarrier | | Table 2 |
| [symbol] | | |
| ≡ | ≡ | ≡ |
| Compressed beamforming feedback | Na [symbol] | Compressed beamforming feedback matrix in |
| matrix [symbol] for subcarrier [symbol] | | Table 2 |

[symbol]

indicates data missing or illegible when filed

Referring to Table 1, the EHT Compressed Beamforming Report field includes fields representing an SNR measured by a beamformer. The SNR may be an average of each spatial stream for all data subcarriers. The number of spatial streams may be defined as Nc.

In addition, the EHT Compressed Beamforming Report field includes fields representing the compressed beamforming feedback matrix for each subcarrier k (where k is a subcarrier index ranging from 0 to Ns, and Ns is the number of subcarriers for which the compressed beamforming feedback matrix is transmitted to the beamformer). scidx( ) refers to a subcarrier for which the compressed beamforming feedback matrix is transmitted. A size of each field is defined as Na×(b_{ϕ}+b_{ψ})/2 (where Na is the number of angles, and b_{ϕ} is a bit size of angle Φ, and b_{ψ} is a bit size of angle Ψ).

Hereinafter, Φ is defined as a first angle, and Ψ is defined as a second angle. A bit size may be referred to as a codebook size. The angles may be compressed information of the beamforming feedback matrix measured for each subcarrier. The angles calculated through compression are transmitted through the EHT Compressed Beamforming Report field.

For example, the angles may be included in the EHT Compressed Beamforming Report field in the form of Table 2.

TABLE 2

| Size of V | Number of angles | The order of angles in the Compressed Beamforming |
|---|---|---|
| (Nr × Nc) | (Na) | Feedback Matrix subfield |
| 2 × 1 | 2 | ϕ11, ψ21 |
| 2 × 2 | 2 | ϕ11, ψ21 |
| 3 × 1 | 4 | ϕ11, ϕ21, ψ21, ψ31 |
| 3 × 2 | 6 | ϕ11, ϕ21, ψ21, ψ31, ϕ22, ψ32 |
| 3 × 3 | | ϕ11, ϕ21, ψ21, ψ31, ϕ22, ψ32 |
| 4 × 1 | 5 | ϕ11, ϕ21, ϕ31, ψ21, ψ31, ψ41 |
| 4 × 2 | 10 | ϕ11, ϕ21, ϕ31, ψ21, ψ31, ψ41, ψ22, ϕ22, ϕ32, ψ42 |
| ≡ | ≡ | ≡ |

In Table 2, V is a beamforming feedback matrix. The number of angles Na and the order of the angles may be defined for each size of the beamforming feedback matrix. For example, the number of angles included in a 2×1 beamforming feedback matrix is 2, and the first angle Φ11 and the second angle Ψ21 are included in the beamforming feedback matrix.

The EHT MU Exclusive Beamforming Report field may be included only in the case of MU beamforming. The EHT MU Exclusive Beamforming Report field may transmit explicit feedback in the form of delta SNR. Delta SNR may be defined as a difference between an SNR of each subcarrier and the average SNR. According to example embodiments, a different delta SNR may be provided with respect to each of several subcarriers.

The beamformer may calculate the delta SNR based on Equation 1.

$$Equation 1$$

$$Δ {SNR}_{k , i} = min ( max ( round ( 10 {log}_{10} ( \frac{{‖ {H}_{k} {V}_{k , i} ‖}^{2}}{{P}_{N , i}} ) - {\overline{SNR}}_{i} ) \text{?} - 8 ) , 7 )$$

$$\text{?} \text{indicates text missing or illegible when filed}$$

where ΔSNR_{k,i} is a delta SNR for an i-th stream and a k-th subcarrier,

$$10 {log}_{10} ( \frac{{‖ {H}_{k} {V}_{k , i} ‖}^{2}}{{P}_{N , i}} )$$

is an SNR for the i-th stream and k-th subcarrier, and S̅N̅R̅ᵢ is an average SNR for the i-th stream and may be calculated as

$${\overline{SNR}}_{i} = \overline{10 {log}_{10} ( \frac{{\vert HV \vert}^{2}}{{P}_{N}} )} .$$

S̅N̅R̅ᵢ is represented by an 8-bit combination in the range of [−128, 127] as illustrated in Table 3, and a delta SNR value may be represented by a 4-bit combination in the range of [−8, 7]. For example, the delta SNR may be quantized to the range of [−8, 7] through Equation 1.

The −8 and 7 corresponding to a max operation and a min operator in Equation 1 are a quantization range, which may be set based on the number of quantization bits. Therefore, the quantization range defined in Equation 1 is only an example, and example embodiments are not limited thereto.

TABLE 3

| Average SNR of space-time stream, [symbol] | AvgSNR [symbol] | |
|---|---|---|
| −128 | ≤10 | dB |
| −127 | −9.75 | dB |
| −126 | −9.5 | dB |
| — | — | |
| +126 | 53.5 | dB |
| +127 | ≥53.75 | dB |

[symbol]

indicates data missing or illegible when filed

The beamformer may provide feedback on the delta SNR for each stream for each specified subcarrier.

The EHT CQI Report field may include EHT CQI report information. The average SNR per resource unit (RU) of each spatial stream may be transmitted through the EHT CQI Report field.

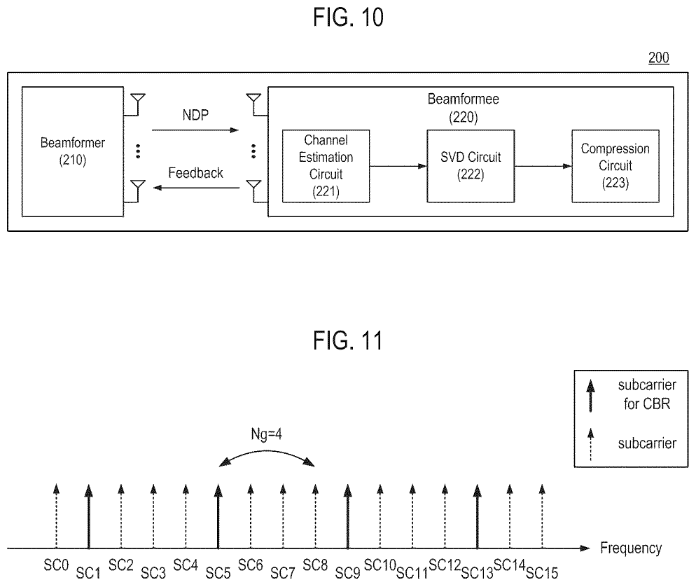

FIG. 10 is a diagram illustrating a WLAN beamforming system.

Referring to FIG. 10, a WLAN beamforming system 200 may include a beamformer 210 and/or a beamformee 220.

The beamformer 210 may transmit the above-described NDPA frame through a plurality of antennas and then transmit NDP to the beamformee 220.

The beamformee 220 may receive the NDP through the plurality of antennas and generate feedback information from the NDP. The beamformee 220 may include a channel estimation circuit 221, a singular value decomposition (SVD) circuit 222, and/or a compression circuit 223 to generate the feedback information.

The channel estimation circuit 221 may be configured to estimate a channel through which signals are transmitted and received. When the transmitted signal is defined as S, the channel as H, the received signal as Y, and noise as N, a relationship between the transmitted signal and the received signal may be defined as in Equation 2.

$$Y [ k ] = H [ k ] S [ k ] + N [ k ] \qquad Equation 2$$

where k is an index of a subcarrier. Hereinafter, F[k] is defined as a vector or matrix F associated with a k-th subcarrier, and may be referred to as ‘F’ for ease of description.

When Ntx and Nrx are defined as the number of transmit antennas and the number of receive antennas, respectively, S may be defined as a vector having a size of Ntx×1 and H may be defined as a matrix having a size of Nrx×Ntx.

A channel estimator may estimate the channel H based on the NDP. In Equation 2, NDP may be considered to be Y.

The SVD circuit 222 may perform singular value decomposition (SVD) on the channel estimated by the channel estimator. For example, an SVD equation for the estimated channel may be defined as in Equation 3.

$$H [ k ] = U [ k ] \sum [ k ] {V [ k ]}^{H} \qquad Equation 3$$

where U and VH are unitary matrices that are defined as a left unitary matrix and a right unitary matrix, respectively. VH is a Hermitian transpose of V. V may be considered to include information on a transmit antenna side. Σ is a diagonal matrix including channel singular values. Therefore, for optimal (or improved) beamforming, the beamformee 220 may transmit V as feedback information to the beamformer 210. Hereinafter, V is defined as a beamforming feedback matrix, meaning it is used for beamforming. However, transmitting V as it is may result in significant feedback overhead.

The SVD circuit 222 may perform various compression operations on the beamforming feedback matrix. For example, the SVD circuit 222 may perform a common-phase shift on the beamforming feedback matrix. The SVD circuit 222 may calculate a phase-shifted matrix Q by multiplying the beamforming feedback matrix by a diagonal matrix \tilde{D} for the common-phase shift as illustrated in Equation 4.

$$Q [ k ] = V [ k ] \tilde{D} \qquad Equation 4$$

The diagonal matrix \tilde{D} may be defined as

$$\tilde{D} ( {e}^{- j {ϕ}_{{N}_{t} - 1}} , … , {e}^{- j {ϕ}_{{N}_{t - 1} , {N}_{t - 1}}} )$$

having e^{-jϕ}^{_{t,j}} as an element. In Equation 4, Nt is a row size of the beamforming feedback matrix and may correspond to the number of transmit antennas, and e^{-jϕ}^{_{i,j}} is defined as a phase value corresponding to an element in an i-th row and a j-th column of the beamforming feedback matrix. For example, e^{-jϕN}^{ₜ}^{,1} is a phase value corresponding to an element in of an Nt-th row and a first column of the beamforming feedback matrix V. An element corresponding to the last row of each column of the phase-shifted matrix has a real value.

The compression circuit 223 may compress the phase-shifted matrix Q calculated by the SVD circuit 222 through Givens rotation. For example, compression may be performed through Equations 5 to 7.

$$Q [ k ] = [ {\prod }_{i = 1}^{min ( {N}_{r} , {N}_{t} - 1 )} [ {D}_{i} ( {1}_{i - 1} , {e}^{j {ϕ}_{\text{?}}} , … , {e}^{j {ϕ}_{{N}_{L - 1} , i}} , 1 ) {\prod }_{l = i + 1}^{{N}_{t}} {G}_{li}^{T} ( {ψ}_{\text{?}} ) ] ] {I}_{Nt \times Nr} \qquad Equation 5$$

$$\text{?} \text{indicates text missing or illegible when filed}$$

where lᵢ₋₁ is a vector having a length i−1, where all elements are 1,

$${G}_{li}^{T} ( {ψ}_{li} ) \qquad Equation 6$$

is a Hermitian transpose of a Givens rotation matrix Gₗᵢ(ψ), and Ĩ_{Nt×Nr} is an equivalent matrix having a size of Nt×Nr, and Nr is a column size of the beamforming feedback matrix (for example, the number of receive antennas).

In Equation 5,

$${D}_{l} ( {1}_{l - 1} , {e}^{j {ϕ}_{\text{?}}} , … , {e}^{j {ϕ}_{{N}_{r - 1} , \text{?}}} , 1 )$$

$$\text{?} \text{indicates text missing or illegible when filed}$$

may be defined as a diagonal matrix as illustrated in Equation 6.

$${D}_{i} ( {1}_{\text{?}} , {e}^{j {ϕ}_{\text{?}}} , … , {e}^{j {ϕ}_{\text{?}}} , 1 ) = [ \begin{matrix}{l}_{i - 1} & 0 & … & … & 0 \\ 0 & {e}^{j {ϕ}_{\text{?}}} & 0 & … & 0 \\ ⋮ & 0 & ⋱ & 0 & 0 \\ ⋮ & ⋮ & 0 & {e}^{j {ϕ}_{{N}_{t - 1} , \text{?}}} & 0 \\ 0 & 0 & 0 & 0 & 1\end{matrix} ]$$

$$\text{?} \text{indicates text missing or illegible when filed}$$

In addition, the Givens rotation matrix Gₗᵢ(ψ) in Equation 5 may be defined as Gui (W) illustrated in Equation 7.

$${G}_{li} ( ψ ) = [ \begin{matrix}{I}_{l - 1} & 0 & 0 & … & 0 \\ 0 & cos ( ψ ) & 0 & sin ( ψ ) & 0 \\ 0 & 0 & {I}_{l - i - 1} & 0 & 0 \\ 0 & - sin ( ψ ) & 0 & cos ( ψ ) & 0 \\ 0 & 0 & 0 & 0 & {I}_{Nt - 1}\end{matrix} ] \qquad Equation 7$$

The compression circuit 223 may obtain a first angle and a second angle, two pieces of angle information, by compressing the phase-shifted matrix Q.

The compression circuit 223 may quantize the obtained two pieces of angle information. The compression circuit 223 may quantize the first angle having a bit size of b_{ϕ} and the second angle having a bit size of b_{ψ}. For example, the compression circuit 223 may quantize the first angle based on Equation 8 and the second angle based on Equation 9.

$${\hat{ϕ}}_{ji}^{( k )} = \frac{n π}{{2}^{{b}_{ϕ} - 1}} + \frac{π}{{2}^{{b}_{ϕ}}} , n = 1 , 2 , … , {2}^{{b}_{ϕ} - 1} \qquad Equation 8$$

$${\hat{ψ}}_{ji}^{( k )} = \frac{n π}{{2}^{{b}_{ψ} - 1}} + \frac{π}{{2}^{{b}_{ψ}}} , n = 1 , 2 , … , {2}^{{b}_{ψ} - 1} \qquad Equation 9$$

where

$${\hat{ϕ}}_{ji}^{( k )}$$

is a quantized first angle, and

$${\hat{ψ}}_{ji}^{( k )}$$

is a quantized second angle. The quantized first angle has a value from 0 to 2π, and the quantized second angle has a value from 0 to π/2.

Codebook sizes b_{ϕ} and b_{ψ} for the first and second angles for quantization may be defined depending on SU or MU, as illustrated in Table 4.

TABLE 4

| | |
|---|---|
| SU | MU |

| | Coarse | Fine | Coarse | Fine |
|---|---|---|---|---|
| {b_{ϕ}, b_{ϕ}} | Codebook | Codebook | Codebook | Codebook |
| 11ac/ax/be | {2, 4} | {4, 6} | {5, 7} | {7, 9} |

As illustrated in Table 4, in the IEEE 802.11ac/ax/be standard, the codebook size for a coarse codebook for single-user beamforming is defined as {2, 4} and the codebook size for a coarse codebook is defined as {4, 6}. The codebook size for a rough codebook is defined as {5, 7} and the codebook size for a precise codebook is defined as {7, 9} to perform multi-user beamforming.

In an EHT trigger-based sounding sequence, the STA Info field within the NDPA frame requesting SU or MU feedback may be identified and used by the beamformee 220 to generate SU or MU feedback. For example, the beamformer 210 may specify grouping, Ng, codebook size, and/or the number of columns of the beamforming feedback matrix to be used by the beamformer 210 through the STA Info field. Then, the beamformee 220 may quantize and provide feedback on the channel information (for example, a plurality of pieces of angle information) based on the indicated parameters.

In an EHT non-trigger-based sounding sequence, the STA Info field within the EHT NDPA frame may request SU feedback. The beamformee 220 may determine grouping, Ng, codebook size, and/or the number of columns of the beamforming matrix.

According to the above-described examples, the beamformee 220 may estimate a channel through the channel estimation circuit 221, obtain a beamforming feedback matrix through singular value decomposition from the estimated channel, obtain two pieces of angle information (the first angle and the second angle) through compression of the beamforming feedback matrix, and quantize the angle information. The beamformee 220 may provide feedback on the quantized angle information as channel information to the beamformer 210.

FIG. 11 is a diagram illustrating subcarrier grouping.

Referring to FIG. 11, in the subcarrier grouping, a beamformee may not provide feedback on channel information (for example, the above-described angle information) for all subcarriers, but may provide feedback on channel information for only a portion of the subcarriers. The subcarrier grouping may be performed based on Ng, a grouping value Ng for subcarrier grouping.

The Ng value is a grouping value indicating a feedback unit of channel information. The Ng value may be determined by the beamformer or the beamformee. For example, the beamformer may indicate the Ng value to the beamformee through the STA Info field in the NDPA frame. Alternatively, the beamformee may determine the Ng value for itself in an EHT non-trigger-based sounding sequence. For example, the Ng value may be specified by the beamformer in multi-user beamforming, and may be determined by the beamformee in single-user beamforming.

When the Ng value is determined, the beamformee may provide feedback on channel information corresponding to a single subcarrier among Ng consecutive subcarriers. For example, the beamformee may report only a single compressed beamforming feedback matrix for each group of the Ng consecutive subcarriers. For example, when the Ng value is determined to be 4 as illustrated in FIG. 11, the beamformee may provide feedback on channel information in units of 4 subcarriers.

For example, in FIG. 11, the beamformee may provide feedback on channel information for each of the subcarriers SC1, SC5, SC9, and SC13 among subcarriers SC0 to SC15.

The Ng value may be defined according to the IEEE 802.11 standard. For example, in 802.11ac, the Ng value may be 1, 2, or 4, while in 802.11ax/be, the Ng value may be 4 or 16. When the Ng value is 1, the beamformee may provide feedback on channel information for all subcarriers.

Hereinafter, descriptions will be provided for example embodiments in which, when feedback on a plurality of pieces of channel information (for example, a plurality of pieces of angle information and a delta SNR) is provided, overhead of the feedback information is reduced. An STA (for example, a beamformee) may be configured to perform AI-based encoding to reduce the overhead of feedback information. Hereinafter, AI-based encoding may be referred to as autoencoding.

In addition, a plurality of pieces of channel information (or a plurality of pieces of feedback information), to which AI-based encoding is applied, may include at least one of the plurality of pieces of angle information (the first angle and the second angle) and the delta SNR. In example embodiments, the plurality of pieces of channel information may include various pieces of channel-related information that may be reported to the AP, in addition to the plurality of pieces of angle information and the delta SNR, such as the average SNR.

The plurality of pieces of angle information and the delta SNR may be measured or estimated for each subcarrier. Hereinafter, the first angle for a k-th subcarrier may be defined as ϕₖ, the second angle for the k-th subcarrier is defined as ψₖ, and the delta SNR for the k-th subcarrier is defined as ΔSNRₖ. Also, hereinafter, the plurality of pieces of channel information may be defined as being compressed and quantized through a compression circuit. For example, compression and quantization of the plurality of pieces of angle information may be performed based on the above-described Equations 5 to 9.

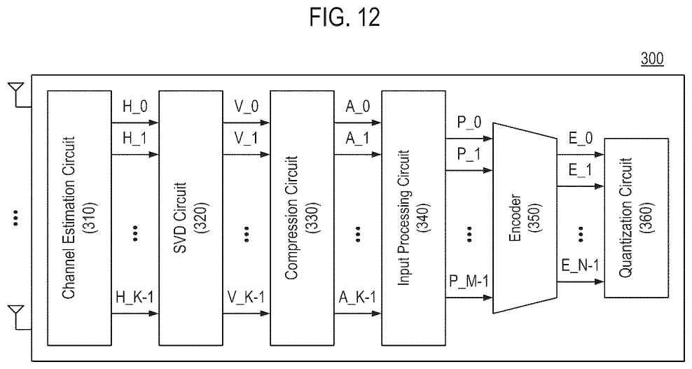

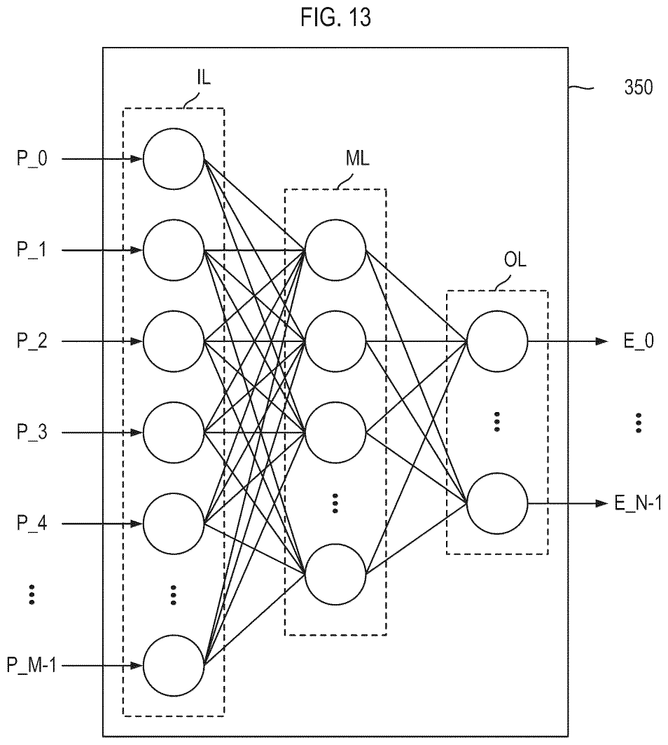

FIG. 12 is a diagram illustrating an STA according to example embodiments.

Referring to FIG. 12, an STA 300 according to example embodiments may further include an input processing circuit 340, an encoder 350, and/or a quantization circuit 360 in addition to the channel estimation circuit 310, the SVD circuit 320, and/or the compression circuit 330 according to the above-described examples. According to example embodiments, the channel estimation circuit 310, the SVD circuit 320, and/or the compression circuit 330 may be the same as or similar to the channel estimation circuit 221, the SVD circuit 222, and/or the compression circuit 223, respectively

The channel estimation circuit 310 according to example embodiments may estimate a channel from sounding NDP received from an AP and provide K estimated channels H_0 to H_K−1 to the SVD circuit 320, where K is a size of channel information and may also be defined as the number of subcarriers for which the channel is estimated and/or the number of subcarriers for which the channel information is transmitted. For example, the estimated channel may be estimated for each of the K subcarriers.

The SVD circuit 320 may obtain K beamforming feedback matrices V_0 to V_K−1 through SVD of the K estimated channels H_0 to H_K−1, and provide the obtained K beamforming feedback matrices V_0 to V_K−1 to the compression circuit 330.

The compression circuit 330 may be configured to obtain K pieces of angle information A_0 to A_K−1 as channel information through compression and quantization of the K beamforming feedback matrices V_0 to V_K−1. For example, a plurality of pieces of angle information may include a first angle and a second angle, and ‘K’ may be defined for each angle. For example, K1 first angles (where K1 is the number of subcarriers for which the first angle is estimated and/or the number of subcarriers for which the first angle is transmitted) may be generated through compression. In addition, K2 second angles (where K2 is the number of subcarriers for which the second angle is estimated and/or the number of subcarriers for which the second angle is transmitted) may be generated through compression. K1 and K2 may be the same (or similar) or different from each other, and may be determined by the above-mentioned codebook size. In FIG. 12, the number of the plurality of pieces of angle information (e.g., the quantity of pieces of angle information) is collectively referred to as ‘K’ for ease of description.

The channel estimation circuit 310, the SVD circuit 320, and the compression circuit 330 may be configured or operated according to the above-described examples, and detailed descriptions thereof will be omitted to avoid (or reduce) repetition.

The input processing circuit 340 may be configured to process channel information, enabling the channel information to be input to the encoder 350. According to example embodiments, the input processing circuit 340 may reshape a size of the channel information or preprocess (or process) the channel information.

In example embodiments, the input processing circuit 340 may convert the size of the channel information to match a size of an input layer of the encoder 350 configured to encode the channel information. For example, the input processing circuit 340 may reshape the size of the channel information, enabling the channel information to be input to the encoder 350. Reshaping the size may include expansion and/or shrinkage.

The encoder 350 may be configured as an AI model to encode the channel information, reducing the overhead of channel information feedback. For example, the encoder 350 may be configured as a neural network including an input layer, one or more middle layers, and/or an output layer. A size of the input layer may be defined as M (where M is a positive integer), and M may be defined as the number of nodes included in the input layer.

The encoder 350 may be trained through machine learning to encode the channel information, input data input to the encoder 350. The trained encoder 350 may encode and output the channel information to reduce the feedback overhead on a beamformee side.

The size of the channel information input to the encoder 350 may vary depending on the type of channel information (for example, angle information, delta SNR, or the like). When original information is input to the encoder 350 as it is without reshaping the size of the channel information, there may be channel information that does not match the size of the input layer. An encoder 350 may be provided for each channel information to encode the non-matching channel information. For example, an encoder 350, including input layers with varying sizes or numbers of nodes depending on the size of the channel information, may be provided for each set of channel information.

In example embodiments, the input processing circuit 340 may reshape the size of the channel information to use an encoder 350 that may be commonly configured for all pieces of channel information. The input processing circuit 340 may compare the size of the angle information, the channel information, with the size of the input layer. When the size of the channel information is the same as (or similar to) the size of the input layer, size reshaping may not be performed. For example, the channel information may be input to the encoder 350 as it is.

When the channel information has a larger size than the input layer, the input processing circuit 340 may reduce the size of the channel information. In example embodiments, the input processing circuit 340 may divide the channel information into L groups (where L is a positive integer) based on the channel information having a larger size than the input layer.

L may be defined as ┌K/M┐ For example, L may be a result of a ceiling function for K/M.

The input processing circuit 340 may perform padding on one of the L groups having a smaller size than the input layer. For example, the channel information corresponding to the remaining groups except for one group may have the same size as (or a similar size to) the input layer through the division. The one group may have a smaller size than the input layer.

Accordingly, the input processing circuit 340 may perform padding on a channel information area when a size of the channel information area is insufficient for the input layer within one group, enabling the one group to have the same size as (or a similar size to) the input layer.

When the channel information has a smaller size than the input layer, the input processing circuit 340 may increase the size of the channel information. In example embodiments, the input processing circuit 340 may perform padding on the channel information based on the channel information having a smaller size than the input layer. Only the insufficient area needs to (or otherwise, may) be padded, so that the grouping is not required (or otherwise, implemented).

Accordingly, the input processing circuit 340 may perform padding on the channel information area when the size of the channel information area that is insufficient for the input layer in the current channel information, enabling the channel information to have the same size as (or a similar size to) the input layer.

For example, in the above-described examples, the padding may be zero-padding to fill an area to be padded with 0. Alternatively, the input processing circuit 340 may perform padding based on an arbitrary (or otherwise, given) real value other than 0.

A common encoder 350 may be employed, regardless of the type of channel information (for example, the first angle and the second angle), through the input processing circuit 340 according to the above-described examples. For example, the encoder 350 may be configured commonly for a plurality of pieces of angle information.

In example embodiments, the input processing circuit 340 may perform preprocessing (or processing) on the channel information. For example, the preprocessing (or processing) may be normalization.

For example, the input processing circuit 340 may perform preprocessing (or processing) before inputting channel information having a reshaped size to the encoder 350 to improve the machine learning performance of the encoder 350. For example, the input processing circuit 340 may normalize the angle information based on Equations 10 and 11.

$$f ( {ϕ}_{k} ) = \frac{( {ϕ}_{k} )}{{2}^{{b}_{ϕ}}} \qquad Equation 10$$

$$f ( {ψ}_{k} ) = \frac{( {ψ}_{k} )}{{2}^{{b}_{ψ}}} \qquad Equation 11$$

where f( ) is a normalization function, and [symbol] (⋅) is a quantization function. For example, the input processing circuit 340 may normalize a plurality of pieces of quantized angle information to a range between 0 and 1 based on the codebook size b_{ϕ} and b_{ψ}. Accordingly, the amount of data in the plurality of pieces of angle information may be reduced.

The input processing circuit 340 may provide M pieces of processed angle information P_0 to P_M−1 to the encoder 350 through size reshaping and/or preprocessing (or processing) of the K pieces of angle information A_0 to A_K−1.

The encoder 350 may encode the M pieces of processed angle information P_0 to P_M−1 and provide N pieces of encoded angle information E_0 to E_N−1 to the quantization circuit 360 (where N is a positive integer).

The quantization circuit 360 may quantize the N pieces of encoded angle information E_0 to E_N−1. For example, the quantization circuit 360 may quantize the N pieces of encoded angle information based on the codebook size \tilde{b}_{ϕ} and \tilde{b}_{ψ} defined to quantize the N pieces of encoded angle information. For ease of description, when \tilde{b}_{ϕ} and \tilde{b}_{ψ}, are defined as a first codebook size and \tilde{b}_{ϕ} and \tilde{b}_{ψ} are defined as a second codebook size, the first codebook size is used to quantize the N pieces of angle information before encoding, and the second codebook size is used to quantize the N pieces of angle information after encoding.

The STA 300 may provide feedback on the N pieces of encoded angle information, obtained according to the above-described examples, to the AP.

According to the above-described examples, the STA 300 may reduce the feedback overhead to the AP through a single encoder 350, which is commonly configured for the channel information, and by performing processing such as shaping the size of the channel information to be input to the encoder 350. For example, only one encoder 350 is commonly configured regardless of the type of channel information, so that an optimization (or improvement) process required (or otherwise, used) for machine learning may be reduced. In addition, encoding may be performed even when only one encoder 350 is used by processing channel information, input data of the encoder 350.

FIG. 13 is a diagram illustrating an encoder of FIG. 12 according to example embodiments.

Referring to FIG. 13, the encoder 350 according to example embodiments may be configured as a neural network including an input layer IL, a middle layer ML, and/or an output layer OL. In FIG. 13, the encoder 350 is illustrated as including a single middle layer ML for ease of description. However, example embodiments are not limited thereto, and a plurality of middle layers ML may be provided.

When the number of nodes in the input layer IL is M, a size of the input layer IL is defined as M. Therefore, the number of data input to the input layer IL is also M. A plurality of pieces of input data P_0 to P_M−1 may be a plurality of pieces of angle information having reshaped sizes according to the above-described examples, or a plurality of pieces of angle information having reshaped and normalized sizes.

The number of nodes included in the middle layer ML and the output layer OL may be configured in various ways. When the number of nodes included in the output layer OL is defined as N, the number of the plurality of pieces of encoded angle information E_0 to E_N−1 output through the encoder 350 is N.

The encoder 350 according to example embodiments may be configured commonly for the plurality of pieces of angle information. In addition, the encoder 350 may be configured commonly for the bandwidth and grouping value of the sounding NDP. For example, the encoder 350 may have the same configuration (or a similar configuration) even when the plurality of pieces of angle information, the bandwidth, and/or the grouping value is changed. For example, the same encoder 350 (or similar encoders 350) may be configured for both cases where the bandwidth is set to 20 MHz or 80 MHz, and the same encoder 350 (or similar encoders 350) may be provided for both a case in which the Ng value is set to 4 and a case in which the Ng value is set to 16.

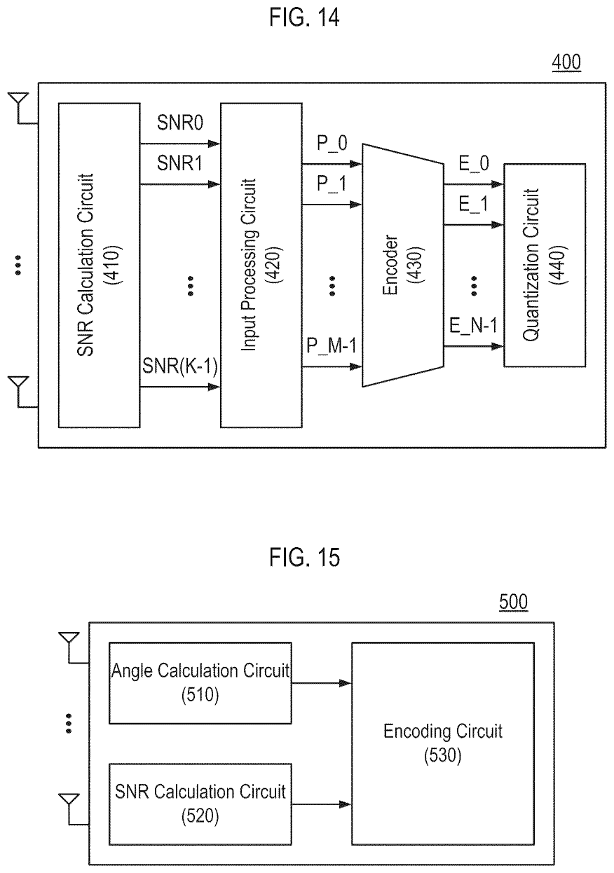

FIG. 14 is a diagram illustrating an STA according to example embodiments.

Referring to FIG. 14, an STA 400 according to example embodiments may include an SNR calculation circuit 410, an input processing circuit 420, an encoder 430, and/or a quantization circuit 440. According to example embodiments, the input processing circuit 420, the encoder 430 and/or the quantization circuit 440 may be the same as or similar to the input processing circuit 340, the encoder 350 and/or the quantization circuit 360, respectively.

The SNR calculation circuit 410 may calculate an SNR from a stream received by the STA 400. For example, the SNR calculation circuit 410 may calculate an average SNR from the stream, or may calculate a delta SNR for a stream and a subcarrier. Accordingly, the delta SNR may be calculated K times, which is the number of subcarriers for which the SNR is calculated, similarly to a plurality of pieces of angle information. The K may be defined to be different for each type of channel information, and the delta SNR may also be defined as being calculated K3 times to be distinguished from the plurality of pieces of angle information.

The SNR calculation circuit 410 may quantize the calculated average SNR and/or delta SNR. For example, the calculation and quantization of delta SNR may be performed based on the above-mentioned Equation 1. According to example embodiments, a quantization range may be set based on b_{Δsnr}, the number of bits for SNR quantization.

The SNR calculation circuit 410 may provide K pieces of SNR information SNR0 to SNR(K−1) to the input processing circuit 420. The input processing circuit 420 may convert a size K of the SNR information, channel information, to match the size M of the input layer of the encoder 430 according to the above-described examples. For example, when K is larger than M, the input processing circuit 420 may divide the K pieces of SNR information SNR0 to SNR(K−1) into L groups and perform padding on one of the L groups. Accordingly, each of the L groups may be converted to be input to the input layer.

Alternatively, when K is smaller than M, the input processing circuit 420 may perform padding on SNR information that is insufficient from M. Therefore, the K SNR information SNR0 to SNR(K−1) may be expanded to M pieces of SNR information.

The input processing circuit 420 according to example embodiments may perform preprocessing (or processing) (for example, normalization) on SNR information having a reshaped size. For example, the input processing circuit 420 may perform normalization on delta SNR information having a reshaped size, based on Equation 12.

$$f ( Δ {SNR}_{k} ) = \frac{Δ {SNR}_{k}}{{2}^{b Δ snr}} \qquad Equation 12$$

where f( ) is a normalization function. The input processing circuit 420 may reduce the amount of data in the SNR information through normalization.

The input processing circuit 420 may provide M pieces of processed SNR information P_0 to P_M−1 to the encoder 430, and the encoder 430 may encode the SNR data having a size reshaped or preprocessed (or processed) by the input processing circuit 420. The encoder 430 may provide N pieces of encoded SNR data E_0 to E_M−1 to the quantization circuit 440, and the quantization circuit 440 may quantize the encoded SNR data.

The STA 400 may provide feedback on the quantized SNR data as feedback information to the AP.

The STA 400 according to the above-described examples may encode the channel information using a single encoder 430 by converting the size of the SNR data to match the size of the input layer of the encoder 430.

FIG. 15 is a diagram illustrating an STA according to example embodiments.

Referring to FIG. 15, an STA 500 according to example embodiments may include an encoding circuit 530 including elements for encoding according to the above-described examples (for example, the input processing circuit, the encoder, and the quantization circuit of FIGS. 12 and 14) configured commonly for channel information such as a plurality of pieces of angle information and SNR. For example, the STA 500 may include an angle calculation circuit 510 including elements for obtaining angle information (for example, the channel estimation circuit 310, the SVD circuit 320, and the compression circuit 330 of FIG. 12) and an encoding circuit 530 configured commonly for an SNR calculation circuit 520 (for example, the SNR calculation circuit 410 of FIG. 14).

The encoding circuit 530 may receive K1 first angles and K2 second angles from the angle calculation circuit 510, and/or K3 pieces of SNR information (for example, delta SNR) from the SNR calculation circuit 520. The encoding circuit 530 may compare K1 to K3 with the size M of the input layer of the encoder, and may expand or shrink the size of the plurality of angle information and/or the delta SNR based on a result of the comparison. The encoding circuit 530 may encode the channel information having a reshaped size through the encoder. A single encoder may be configured commonly for all pieces of channel information, the bandwidth of the sounding NDP, and/or the grouping value.

The encoding circuit 530 may quantize the encoded channel information.

The STA 500 may finally provide feedback on the encoded channel information to the AP.

The STA 500 according to the above-described examples may reduce software/hardware elements for the encoder and an optimization (or improvement) process required (or otherwise, used) for machine learning by commonly configuring only one encoder, rather than configuring additional encoders for each type of channel information, bandwidth, and grouping value. In addition, the configuration of the single encoder may be achieved through processing of channel information (for example, size reshaping and preprocessing).

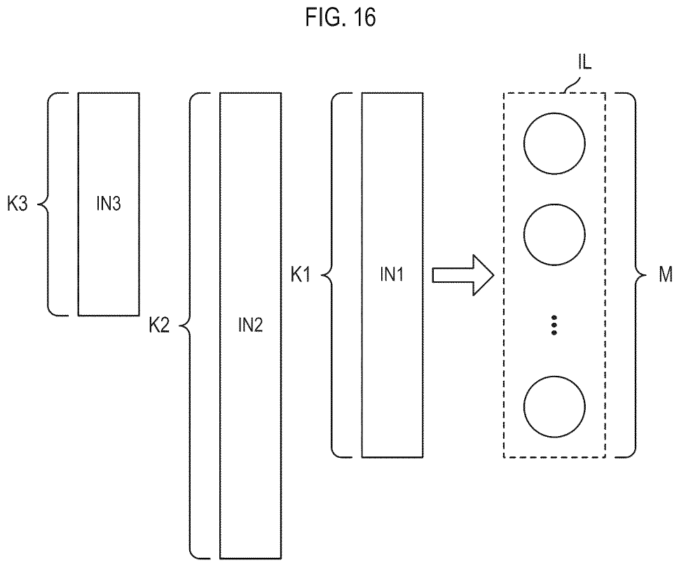

FIGS. 16 to 18 are diagrams illustrating a processing operation of input data of an encoder according to example embodiments.

Referring to FIG. 16, an example is provided in which when a size of an input layer IL of the encoder is M, first input data IN1 having a size K1, second input data IN2 having a size K2, and third input data IN3 having a size K3 are input to the input layer IL. In addition, an example is provided in which K1 is equal to M, K2 is larger than M, and K3 is smaller than M. Each of the first to third input data IN1 to IN3 may correspond to one of a plurality of pieces of channel information (for example, a first angle, a second angle, delta SNR information, or the like).

The first input data IN1 may be an M×1 matrix, the second input data IN2 may be a K2×1 matrix, and the third input data IN3 may be a K3×1 matrix. Accordingly, the first input data IN1 may be applied to the input layer IL as it is, but the second input data IN2 and the third input data IN3 may not be applied as it is.

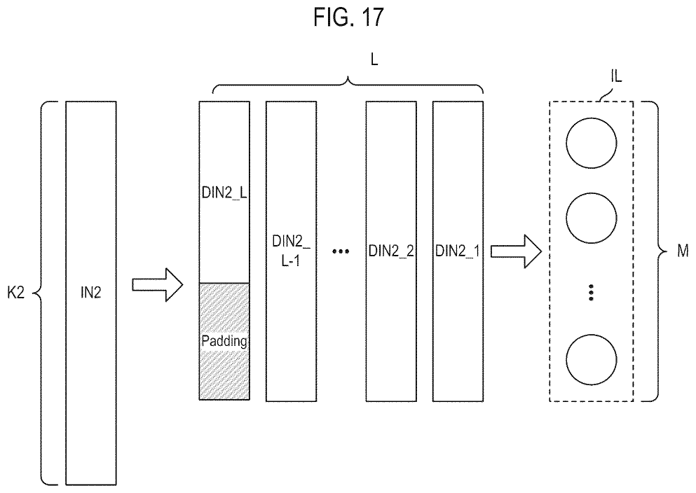

Referring to FIG. 17, an STA according to example embodiments may reduce a size of second input data IN2, which is larger than a size M of the input layer IL. For example, the STA may divide the second input data IN2 into L groups. A size of each of first to (L−1)-th groups, among the L groups, is equal to M, but a size of an L-th group (e.g., only one L group) is smaller than M.

The STA may expand the size of the L-th group to match M. To expand, the STA may perform padding on an insufficient area in the L-th group to expand the size of the L-th group. Due to the padding, the size of the L-th group including additionally included padding data may also match M. Accordingly, the STA may input each of the L groups to the encoder to perform encoding.

The expansion will now be described in terms of an index of input data. When the second input data IN2 is indexed from 0, a plurality of pieces of channel information included in the second input data IN2 may have indices of 0 to K−1 (e.g., K2-1). As described above, each index may correspond to a subcarrier. When the second input data IN2 is divided into L groups DIN2_1 to DIN_L, the remaining groups except for the L-th group have M pieces of channel information. However, channel information from index K (e.g., K2) to index (L*M−1) is not present in the L-th group DIN_L. According to example embodiments, the L groups may have (collectively) indices from 0 to (L*M−1).

Accordingly, the STA may perform padding on the channel information from index K (e.g., K2) to index (L*M−1) in the L-th group DIN_L to expand the size of the L-th group DIN_L to M.

For example, when M=64 and K2=250, L is defined as ┌K/M┐. The first group includes channel information from indices 0 to 63, and the second group includes channel information from indices 64 to 127. The L-th group (for example, the fourth group) includes channel information from indices 192 to 249. Accordingly, 6 pieces of channel information corresponding to indices 250 to 255 are insufficient to input the fourth group to the encoder.

The STA may pad data corresponding to indices 250 to 255 to expand a size of the fourth group to 64. For example, when zero-padding is performed, the indices 192 to 249 in the fourth group may correspond to the channel information and the indices 250 to 255 may correspond to 0 (e.g., bits each having the value of ‘0’).

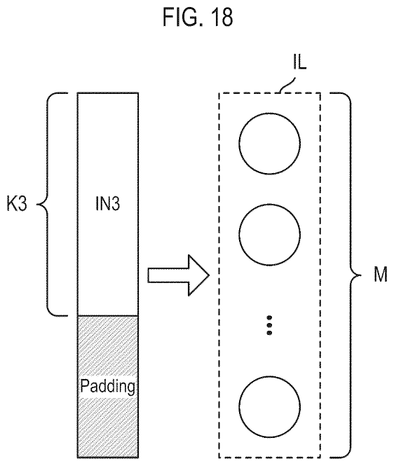

Referring to FIG. 18, an STA according to example embodiments may expand a size of third input data IN3, which is smaller than a size M of an input layer IL. Similarly to the expansion of the L-th group in FIG. 17, padding may be used for expansion.

The STA may expand the size of the third input data IN3 to match M through padding (e.g., by adding bits each having the value of ‘0’). According to example embodiments, the bits added through padding may have a quantity equal to the difference between the bit sizes of M and the third input data IN3. The STA may input the expanded third input data IN3 to the encoder to perform encoding.

A description will now be provided in terms of the index. Channel information from index K (e.g., K3) to index (L*M−1) is not present in the third input data IN3.

Accordingly, the STA may perform padding on the channel information from index K to index (L*M−1) in the third input data IN3 to expand the size of the third input data IN3 to M. According to example embodiments, the converted channel information resulting from the padding may have indices from 0 to M−1.

For example, when M=64 and K3=20, the third input data IN3 includes channel information from indices 0 to 19. Therefore, 44 pieces of channel information corresponding to indices 20 to 63 is insufficient to input the third input data IN3 to the encoder.

The STA may pad data, corresponding to indices 20, to 63 to expand the size of the third input data IN3 to 64.

According to the above-described examples, by reshaping the size of the channel information to be applied to the encoder to match the size of the input layer IL of the encoder, the STA may encode the channel information even when only a single common encoder is used for all pieces of channel information. Accordingly, the software/hardware design complexity and resources required (or otherwise, used) for encoder configuration and machine learning of the encoder may be reduced.

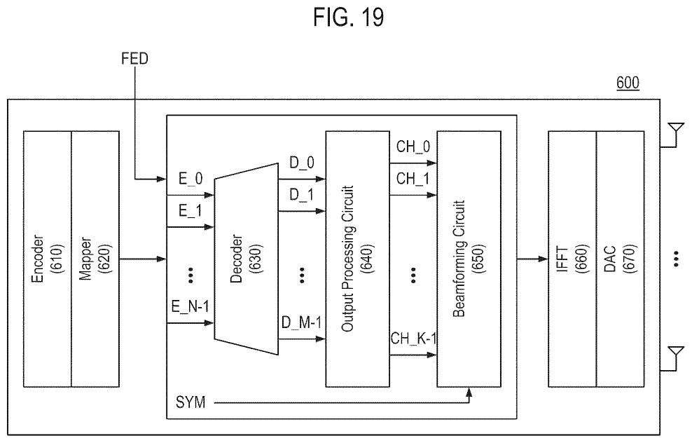

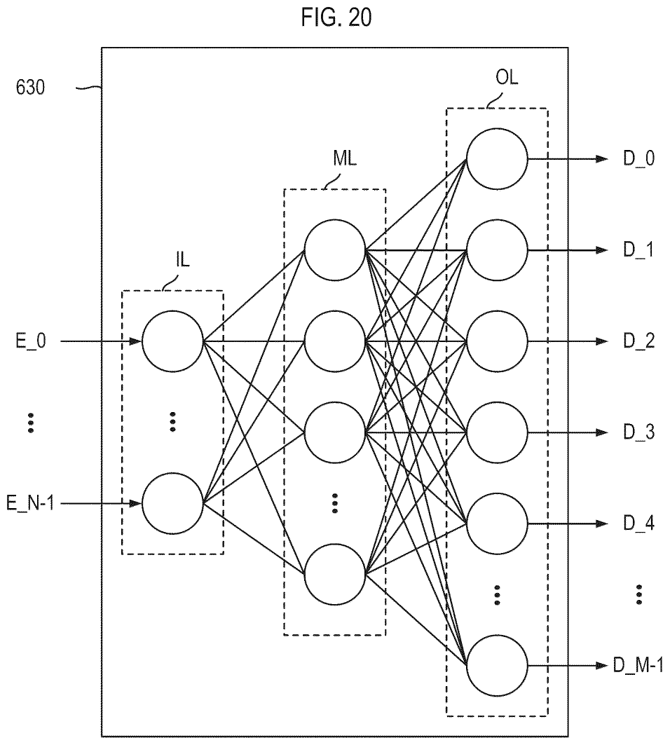

FIG. 19 is a diagram illustrating an access point (AP) according to example embodiments, and FIG. 20 is a diagram illustrating a decoder of FIG. 19 according to example embodiments.

Referring to FIG. 19, the AP 600 according to example embodiments may include an encoder 610, a mapper 620, a decoder 630, an output processing circuit 640, a beamforming circuit 650, an inverse fast Fourier transformer (IFFT) 660, and/or a digital-to-analog converter (DAC) 670.

The encoder 610 may encode an input bit sequence and provide an encoded signal to the mapper 620. The mapper 620 may perform constellation mapping and/or spatial mapping on the encoded signal. A mapped symbol may be transmitted to the beamforming circuit 650.

The decoder 630 may be configured to decode N pieces of encoded channel information E_0 to E_N−1 included in feedback information FED received from the STA. The N pieces of encoded channel information E_0 to E_N−1 may be information quantized in the STA.

Referring to FIG. 20, the decoder 630 may be configured as a neural network including an input layer IL, one or more middle layers ML, and/or an output layer OL, similarly to the encoder (an encoder on the STA side, for example, the encoder 350). In addition, the decoder 630 may have a structure symmetric to the encoder in terms of a direction in which nodes are arranged in each layer. For example, an output layer OL of the encoder may be configured (e.g., with respect to size) as the input layer IL of the decoder 630, and the input layer IL of the encoder may be configured (e.g., with respect to size) as the output layer OL of the decoder 630. Accordingly, the size of the input layer IL of the decoder 630 is N, and the size of the output layer OL is M.

A size of each layer may be defined as the number of nodes included in each layer.

Similarly to the encoder, the decoder 630 may also be trained through machine learning to decode the channel information, input data input to the decoder 630. The trained decoder 630 may decode the channel information, fed back from a beamformee side, to an original state to output M pieces of decoded channel information D_0 to D_M−1.

Returning to FIG. 19, the output processing circuit 640 may perform post-processing (or processing) on the M pieces of decoded channel information D_0 to D_M−1, provided from the decoder 630, to obtain a plurality of pieces of angle information.

The post-processing (or processing) may be defined as performing inverse processes of the size reshaping and preprocessing (or processing) of the channel information on the STA side according to the above-described examples. For example, the output processing circuit 640 may perform an inverse process of preprocessing (or processing) on the decoded channel information, and then perform an inverse process of size reshaping on a result thereof. The inverse process of size reshaping may refer to converting a size of the decoded channel information to match M, the number of subcarriers for which the channel information is transmitted.

The output processing circuit 640 according to example embodiments may perform post-processing (or processing) based on the following Equations 13 to 15.

$${\hat{ϕ}}_{k} = {f}^{- 1} ( {ϕ}_{k} ) \qquad Equation 13$$

$${\hat{ψ}}_{k} = {f}^{- 1} ( {ψ}_{k} ) \qquad Equation 14$$

$$Δ = {f}^{- 1} ( Δ {SNR}_{k} ) \qquad Equation 15$$

where f⁻¹( ) is an inverse function of a normalization function, \hat{ϕ}ₖ is a post-processed (or processed) first angle, \tilde{ψ}ₖ is a post-processed (or processed) second angle, and Δ [symbol] is post-processed (or processed) delta SNR information.

Then, the output processing circuit 640 may remove a padded area from a plurality of pieces of post-processed (or processed) channel information to obtain K pieces of original channel information. As described above, K may be defined based on the channel information.

The beamforming circuit 650 may perform beamforming based on the obtained channel information. The beamforming circuit 650 may calculate a steering matrix based on the obtained channel information and replace a pre-existing (or existing) steering matrix with the calculated steering matrix. Optimal (or improved) beamforming for a transmit signal may be performed using the steering matrix.

The IFFT 660 may perform an inverse Fourier transform on a signal to be transmitted, and the DAC 670 may convert the signal to be transmitted into an analog signal.

The decoder 630 according to the above-described examples may decode the channel information using a decoder 630 configured commonly for each channel information, so that software/hardware components for the decoder 630 and an optimization (or improvement) process required (or otherwise, used) for machine learning may be reduced.

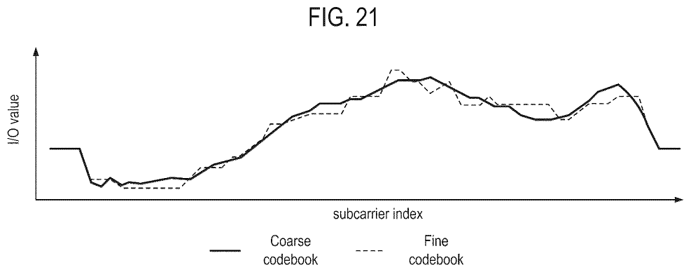

FIG. 21 is a waveform diagram illustrating an example of a resolution for each angle information.

Referring to FIG. 21, when a codebook has a small size (for example, a coarse codebook), a feedback overhead is smaller but a resolution corresponding to in-phase/quadrature (I/Q) values for each subcarrier index is lower. When the codebook has a larger size (for example, a fine codebook), the feedback overhead is larger but the resolution is higher.

The STA according to the above-described examples may encode the channel information to be fed back, similarly to the codebook size that is adaptively reshaped, using a learned AI-based encoder. For example, the encoder may be configured commonly regardless of the type of channel information, bandwidth, grouping value, or the like.

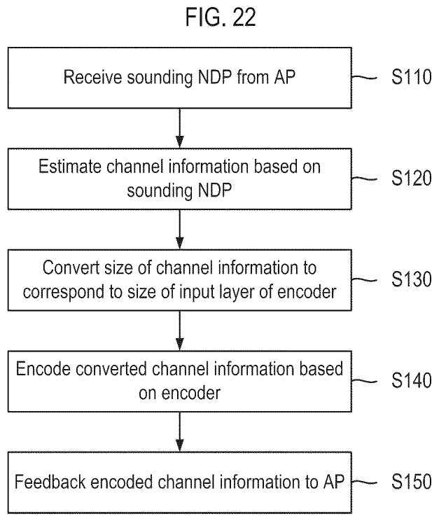

FIG. 22 is a flowchart illustrating a method of operating an STA according to example embodiments. According to example embodiments, the operations of the method illustrated in FIG. 22 may be performed by the STA 300, the STA 400 and/or the STA 500.

Referring to FIG. 22, in operation S110, the STA may receive a sounding NDP from an AP. To receive the sounding NDP, the STA may receive an NDPA frame before receiving the sounding NDP. For example, the STA may receive an NDPA frame from the AP and receive the sounding NDP within SIFS.

In operation S120, the STA may estimate channel information based on the received sounding NDP. The STA may estimate the channel information based on the LTF (for example, EHT-LTF of FIG. 7) included in the sounding NDP. The channel information may include angle information, SNR information, or the like.

In example embodiments, operation S120 may further include an operation of estimating a channel between the AP and the STA based on the sounding NDP, an operation of obtaining a beamforming feedback matrix through SVD of a channel, and/or an operation of obtaining a compressed beamforming feedback matrix including a plurality of pieces of angle information classified as channel information through Givens rotation about the beamforming feedback matrix.

In example embodiments, operation S120 may further include an operation of calculating an average SNR based on the sounding NDP and/or an operation of calculating a delta SNR based on the average SNR.

In operation S130, the STA may convert a size of the channel information to match a size of the input layer of the encoder configured to encode the channel information. The STA may omit operation S130 for channel information having the same size as (or a similar size to) the input layer.

In operation S140, the STA may encode the converted channel information based on the encoder.

In operation S150, the STA may provide feedback on the encoded channel information to an access point (AP). For example, the STA may carry and transmit the encoded channel information encoded in a CBR frame. According to example embodiments, the STA may receive a first signal from the AP that is beamformed according to the encoded channel information (e.g., beamformed according to a steering matrix derived from the encoded channel information), process the first signal to perform one or more among demodulating, downconverting, filtering, amplifying and/or decrypting on the first signal, and perform a further operation(s) based on the processed first signal. For example, the further operation(s) may include one or more of providing the processed first signal to a corresponding application executing on the STA, storing the processed first signal, sending a response signal to the AP (e.g., based on a processing result of the corresponding application executing on the STA), etc.

According to example embodiments, the method may further include an operation of quantizing the channel information based on the codebook size. Operation S130 may be performed on the quantized channel information.

In example embodiments, the method may further include an operation of normalizing the converted channel information based on the codebook size. Operation S140 may be performed on the normalized channel information.

In example embodiments, the method may further include an operation of receiving a BFRP in a trigger-based sounding sequence. The STA may receive the BFRP and receive the sounding NDP within SIFS.

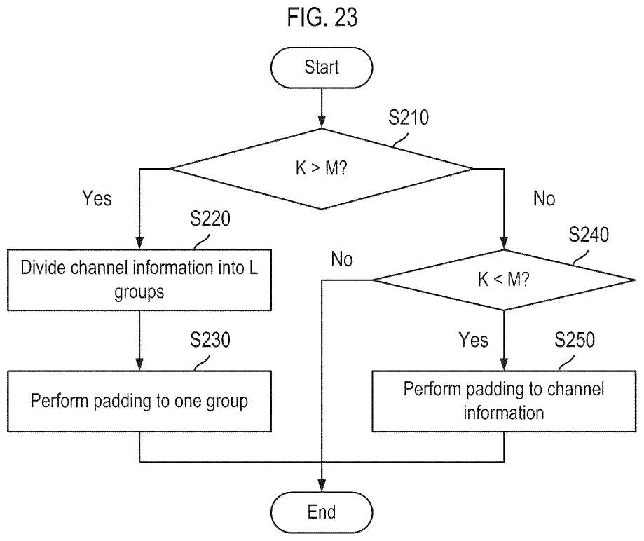

FIG. 23 is a flowchart illustrating a method of converting an STA according to example embodiments. According to example embodiments, the operations illustrated in FIG. 23 may be included within operation S130 discussed above.

Referring to FIG. 23, in operation S210, the STA may determine whether a size K of channel information is larger than a size M of an input layer.

When the size of the channel information is larger than the size of the input layer, the flow proceeds to operation S220 in which the STA may divide the channel information into L groups.

In operation S230, the STA may perform padding on one group having a size smaller than the size of the input layer, among the divided L groups.

In operation S240, the STA may determine whether the size of the channel information is smaller than the size of the input layer (in response to determining the size K of the channel information is not larger than the size M of the input layer in operation S210).

When the size of the channel information is smaller than the size of the input layer, the flow proceeds to operation S250 in which the STA may perform padding on the channel information.

Alternatively, when the size of the channel information is the same as (or similar to) the size of the input layer (e.g., in response to determining the size K of the channel information is not smaller than the size M of the input layer), the STA maintains the size of the channel information without performing padding.

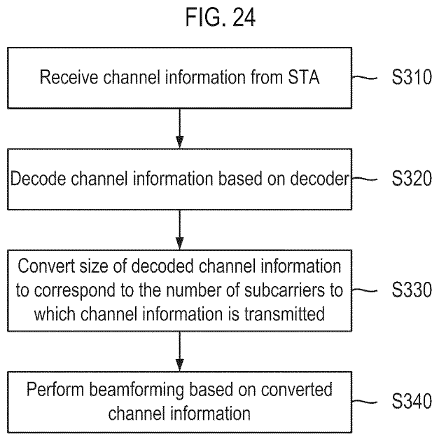

FIG. 24 is a flowchart illustrating a method of operating an AP according to example embodiments. According to example embodiments, the operations of the method illustrated in FIG. 24 may be performed by the AP 600.

Referring to FIG. 24, in operation S310, an AP may receive channel information from the STA. For example, the AP may receive a CBR including channel information from the STA within SIFS after transmitting a sounding NDP. Alternatively, in a trigger-based sounding sequence, the AP may receive a CBR from the STA within SIFS after transmitting the BFRP.

In operation S320, the AP may decode the channel information based on a decoder configured to decode the channel information.

In operation S330, the AP may convert a size of the decoded channel information to match the number of subcarriers for which the channel information is transmitted. For example, when a padded area is present in the decoded channel information, the AP may remove the padded area. When the padded area is not present in the decoded channel information, operation S330 may be omitted.

In operation S340, the AP may perform beamforming based on the converted channel information. Operation S340 may further include an operation of calculating a steering matrix based on the converted channel information. According to example embodiments, the AP may generate a first signal, process the first signal to perform one or more among modulating, upconverting, filtering, amplifying and/or encrypting on the first signal, derive a steering matrix for beamforming the first signal using the converted channel information, and transmit the beamformed first signal to the STA. Additionally or alternatively, the AP may receive a second signal from the STA, process the second signal to perform one or more among demodulating, downconverting, filtering, amplifying and/or decrypting on the second signal, and perform a further operation(s) based on the processed second signal. For example, the further operation(s) may include one or more of providing the processed second signal to a corresponding application executing on the AP, storing the processed second signal, sending a response signal to the STA (e.g., based on a processing result of the corresponding application executing on the AP), etc.

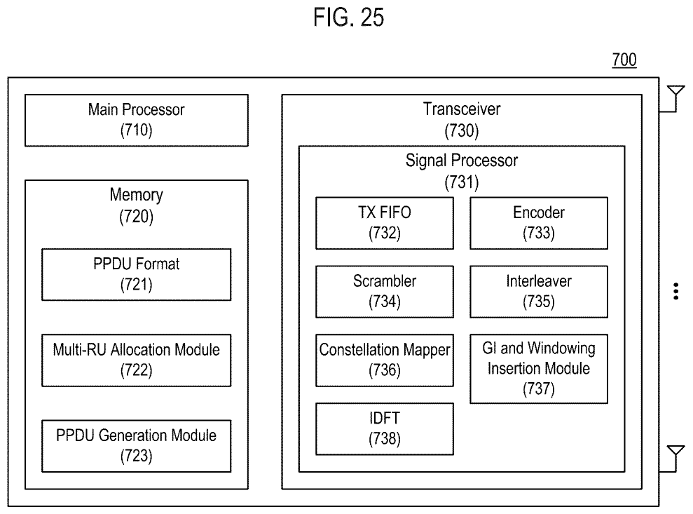

FIG. 25 is a block diagram of a wireless communication device according to example embodiments.

Referring to FIG. 25, a wireless communication device 700 may be a transmitter (for example, an access point AP) or a receiver (for example, a station STA) including a transceiver capable of performing data communications. For example, the wireless communication device 700 of FIG. 25 may be any one of the access points AP1 and/or AP2, and/or the stations STA1, STA2, STA3, and/or STA4, illustrated in FIG. 1, and may be applied to, for example, a computer, a smartphone, a portable electronic device, a tablet PC, a wearable device, a sensor used in the Internet of Things (IoT), or the like. Hereinafter, a description will be provided for an example in which the wireless communication device 700 is a transmitter.

The wireless communication device 700 may include a main processor 710, a memory 720, a transceiver 730, and/or an antenna array. The main processor 710, the memory 720, the transceiver 730, and/or the antenna array may be connected directly or indirectly to each other. At least one of the main processor 710, the memory 720, and/or transceiver 730 may be provided in singular or plural.

The main processor 710 may be electrically connected to the transceiver 730. The main processor 710 may control the memory 720 and the transceiver 730.

According to example embodiments, the main processor 710 may execute one or more instructions, stored in a memory, to receive a sounding NDP from an access point through the transceiver, estimate channel information based on the sounding NDP, convert a size of the channel information to match a size of the input layer of the encoder stored in the memory to encode the channel information, encode the converted channel information based on the encoder, and/or provide feedback on the encoded channel information to the access point through the transceiver.

The memory 720 may be electrically connected to the main processor and may store one or more instructions. In addition, the memory 720 may store PPDU format 721 and bandwidth field information. The transceiver 730 may generate a PPDU using the PPDU format 721 and the bandwidth field information stored in the memory 720. The transceiver 730 may transmit the generated PPDU to an external receiving device (for example, STA) through the antenna array.

The memory 720 may store a PPDU format 721 including a signal field related format according to example embodiments. In addition, the memory 720 may store processor-executable instructions for executing a multi-RE allocation module 722 and a PPDU generation module 723. The processor-executable instructions stored in the memory 720 may be executed by a signal processor 731 included in the main processor 710 or the transceiver 730.

For reference, the multi-RE allocation module 722 may use an RU allocation algorithm, method, or policy to allocate RU to a user (for example, STA) according to example embodiments. In addition, the PPDU generation module 723 may generate signaling and indication related to RU allocation in a control field (for example, also referred to as a signaling field, and hereinafter referred to as a signaling field) of the PPDU.

The memory 720 according to example embodiments may store an encoder and/or a decoder configured commonly for channel information, bandwidth, and/or grouping values. The memory 720 may store training data for machine learning of the encoder and/or the decoder.

The transceiver 730 according to example embodiments may include a signal processor 731. The signal processor 731 may include various modules (for example, various modules of the transmit path) configured to generate each section of a PPDU or various types of communication transmission unit.

FIG. 25 illustrates an example in which the signal processor 731 is included in the transceiver 730, but this is only an example. Example embodiments are not limited thereto, and the signal processor 731 may be implemented as an additional component separate from the transceiver 730.

For example, the signal processor 731 may include a transmit First-In-First-Out (TX FIFO) 732, an encoder 733, a scrambler 734, an interleaver 735, a constellation mapper 736 (which may generate, for example, a QAM symbol), a guard interval and windowing insertion module 737 (which may insert, for example, a guard interval (GI) in a frequency domain to reduce interference on a spectrum and modify a signal through windowing), and/or an inverse discrete Fourier transformer (IDFT) 738.

For reference, the transceiver 730 may include components well known to those skilled in the art as illustrated in the drawing. The components may operate in a manner well known to those skilled in the art, and may be implemented using hardware, firmware, software logic, or combinations thereof.

When the wireless communication device 700 is a receiving device, the transceiver 730 illustrated in FIG. 25 may also include components in a receiving path.

For example, when the wireless communication device 700 is a receiving device, the transceiver 730 may receive a PPDU, including a preamble and a payload, from a transmitting device. In addition, the transceiver 730 may decode the payload based on the preamble of the received PPDU. For example, the transceiver 730 may decode the preamble of the PPDU through an internal decoder, not illustrated, to identify RU allocated to the receiving device, and/or may decode the payload transmitted to the receiving device (for example, the payload received from the transmitting device) based on the identified RU.

A decoding entity may be a component other than the transceiver 730 (for example, the main processor 710, or the like). However, in example embodiments, the decoding entity will be described by way of an example in which the transceiver 730 decodes the payload based on the preamble of the PPDU received by the transceiver 730.

FIG. 25 illustrates only one example of the wireless communication device 700, and example embodiments are not limited thereto. For example, various modifications may be made to FIG. 25.

As set forth above, according to example embodiments, a device and a method for performing a sounding sequence in a wireless communication system may be provided.

Conventional devices and methods for reporting channel information involve transmitting a beamforming feedback matrix (e.g., angle information) and/or a delta SNR. Such channel information is large in size resulting in excessive feedback overhead and corresponding resource consumption (e.g., bandwidth, processor, power, etc.).

However, according to example embodiments, improved devices and methods are provided for reporting channel information. For example, the improved devices and methods may involve encoding the channel information to be reported, thereby reducing the feedback overhead. Also, according to some examples, the improved devices and methods may involve reshaping a size of the channel information to match a size of an input layer of an encoder used to encode the channel information. Accordingly, the encoding of the channel information may be adapted for different implementation cases (e.g., different types of channel information, different bandwidths, different Ng values, etc.). Therefore, the improved devices and methods overcome the deficiencies of the conventional devices and methods to at least reduce resource consumption (e.g., bandwidth, processor, power, etc.) and/or enable adaptable channel information encoding.

According to example embodiments, operations described herein as being performed by the wireless communication system 100, each among the plurality of APs 101 and 103, each among the plurality of STAs 111 to 114, each among the at least one network 130, the WLAN beamforming system 200, the beamformer 210, the beamformee 220, the channel estimation circuit 221, the SVD circuit 222, the compression circuit 223, the STA 300, the channel estimation circuit 310, the SVD circuit 320, the compression circuit 330, the input processing circuit 340, the encoder 350, the quantization circuit 360, the STA 400, the SNR calculation circuit 410, the input processing circuit 420, the encoder 430, the quantization circuit 440, the STA 500, the angle calculation circuit 510, the SNR calculation circuit 520, the encoding circuit 530, the AP 600, the encoder 610, the mapper 620, the decoder 630, the output processing circuit 640, the beamforming circuit 650, the IFFT 660, the DAC 670, the wireless communication device 700, the main processor 710, the transceiver 730, the signal processor 731, the encoder 733, the scrambler 734, the interleaver 735, the constellation mapper 736, the guard interval and windowing insertion module 737, and/or the IDFT 738 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm, and/or functions, described in connection with example embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., the memory 720, the TX FIFO 732, etc.). A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

In example embodiments, the processing circuitry may perform some operations (e.g., the operations described herein as being performed by the encoder 350, the encoder 430, the decoder 630, etc.) by artificial intelligence and/or machine learning. As an example, the processing circuitry may implement an artificial neural network (e.g., the encoder 350, the encoder 430, the decoder 630, etc.) that is trained on a set of training data by, for example, a supervised, unsupervised, and/or reinforcement learning model, and wherein the processing circuitry may process a feature vector to provide output based upon the training. Such artificial neural networks may utilize a variety of artificial neural network organizational and processing models, such as convolutional neural networks (CNN), recurrent neural networks (RNN) optionally including long short-term memory (LSTM) units and/or gated recurrent units (GRU), stacking-based deep neural networks (S-DNN), state-space dynamic neural networks (S-SDNN), deconvolution networks, deep belief networks (DBN), and/or restricted Boltzmann machines (RBM). Alternatively or additionally, the processing circuitry may include other forms of artificial intelligence and/or machine learning, such as, for example, linear and/or logistic regression, statistical clustering, Bayesian classification, decision trees, dimensionality reduction such as principal component analysis, and expert systems; and/or combinations thereof, including ensembles such as random forests.

Herein, the machine learning model (e.g., the encoder 350, the encoder 430, the decoder 630, etc.) may have any structure that is trainable, e.g., with training data. For example, the machine learning model may include an artificial neural network, a decision tree, a support vector machine, a Bayesian network, a genetic algorithm, and/or the like. The machine learning model will now be described by mainly referring to an artificial neural network, but example embodiments are not limited thereto. Non-limiting examples of the artificial neural network may include a convolution neural network (CNN), a region based convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) network, a classification network, and/or the like.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail herein. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

It will be understood that when an element is referred to as being “connected” or “coupled” to another element, it may be directly connected or coupled to the other element or intervening elements may be present. As used herein the term “and/or” includes any and all combinations of one or more of the associated listed items.

Although terms of “first” or “second” may be used to explain various components, the components are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

While example embodiments have been shown and described above, it will be apparent to those skilled in the art that modifications and variations could be made without departing from the scope of the present inventive concepts as defined by the appended claims.

What is claimed is:

1. A method of a station communicating with an access point in a wireless local area network (WLAN) system, the method comprising:
receiving a sounding null data packet (NDP) from the access point;
estimating channel information based on the sounding NDP;
converting a size of the channel information to match a size of an input layer of an encoder to obtain converted channel information;
encoding the converted channel information based on the encoder to obtain encoded channel information; and
providing feedback on the encoded channel information to the access point.

2. The method of claim 1, wherein the channel information comprises:
a plurality of pieces of angle information included in a compressed beamforming feedback matrix; and
a delta signal-to-noise ratio (SNR) defined as a difference between an SNR of a subcarrier and an average SNR.

3. The method of claim 2, wherein
the encoder is configured commonly for the plurality of pieces of angle information and the delta SNR.

4. The method of claim 1, wherein the estimating the channel information comprises:
estimating a channel between the access point and the station based on the sounding NDP to obtain an estimated channel;
performing singular value decomposition (SVD) on the estimated channel to obtain a beamforming feedback matrix; and
performing a Givens rotation of the beamforming feedback matrix to obtain a compressed beamforming feedback matrix, the compressed beamforming feedback matrix including a plurality of pieces of angle information, and the channel information including the plurality of pieces of angle information.

5. The method of claim 1, wherein
the encoder is configured commonly for a bandwidth of the sounding NDP and a grouping value indicating a feedback unit of the channel information.

6. The method of claim 1, wherein
the encoder comprises a neural network, the input layer being included in the neural network, and the neural network further including one or more middle layers and an output layer.

7. The method of claim 1, wherein
a size of the input layer is based on a number of nodes included in the input layer, and
a size of the channel information is based on a number of subcarriers over which the channel information is transmitted.

8. The method of claim 1, wherein the converting the size of the channel information comprises:
dividing the channel information into L groups based on the size of the channel information being larger than the size of the input layer, L being a positive integer; and
performing padding on a single group among the L groups, the single group having a size smaller than the size of the input layer.

9. The method of claim 8, wherein
the L groups have indices from 0 to (L*M−1), M representing the size of the input layer; and
the padding is performed on indices from K to (L*M−1) in the single group, K representing the size of the channel information.

10. The method of claim 1, wherein the converting the size of the channel information further comprises:
performing padding on the channel information based on the size of the channel information being smaller than the size of the input layer.

11. The method of claim 10, wherein
the converted channel information has indices from 0 to M−1, M representing the size of the input layer; and
the padding is performed on the converted channel information having indices from K to (M−1), K representing the size of the channel information.

12. The method of claim 8, wherein
L is defined as ┌K/M┐ K representing the size of the channel information, and M representing the size of the input layer.

13. The method of claim 1, further comprising:
quantizing the channel information based on a codebook size to obtain quantized channel information,
wherein the converting the size of the channel information is performed on the quantized channel information.

14. The method of claim 13, further comprising:
normalizing the converted channel information based on the codebook size to obtain normalized channel information,
wherein the encoding the converted channel information is performed on the normalized channel information.

15. A station communicating with an access point in a wireless local area network (WLAN) system, the station comprising:
one or more transceivers;
one or more processors electrically connected to the one or more transceivers; and
one or more memories electrically connected to the one or more processors and configured to store one or more instructions,
wherein the one or more processors is configured to execute the one or more instructions to,
receive a sounding null data packet (NDP) from the access point through the one or more transceivers,
estimate channel information based on the sounding NDP,
convert a size of the channel information to match a size of an input layer of an encoder to obtain converted channel information, the encoder being stored in the one or more memories,
encode the converted channel information based on the encoder to obtain encoded channel information, and
provide feedback on the encoded channel information to the access point through the one or more transceivers.

16. The station of claim 15, wherein
the channel information comprises:
a plurality of pieces of angle information included in a compressed beamforming feedback matrix, and
a delta signal-to-noise ratio (SNR) defined as a difference between an SNR of a subcarrier and an average SNR; and
the encoder is configured commonly for the plurality of pieces of angle information and the delta SNR.

17. The station of claim 15, wherein
the encoder is configured commonly for a bandwidth of the sounding NDP and a grouping value indicating a feedback unit of the channel information.

18. The station of claim 15, wherein the one or more processors are configured to execute the one or more instructions to:
divide the channel information into L groups based on the size of the channel information being larger than the size of the input layer, L being an integer greater than or equal to 0; and
perform padding on a single group among the L groups, the single group having a size smaller than the size of the input layer.

19. The station of claim 15, wherein the one or more processors are configured to execute the one or more instructions to:
perform padding on the channel information based on the size of the channel information being smaller than the size of the input layer.

20. A method of an access point communicating with a station in a wireless local area network (WLAN) system, the method comprising:
receiving channel information from the station;
decoding the channel information based on a decoder to obtain decoded channel information;
converting a size of the decoded channel information to match a number of subcarriers over which the channel information is transmitted to obtain converted channel information; and
performing beamforming based on the converted channel information.
